(19) United States
(12) Patent Application Publication
(10) Pub. No.: US 2016/0106628 A1
(43) Pub. Date: Apr. 21, 2016

(54) DUAL CONFIGURATION BOTTLE ASSEMBLY

(71) Applicant: Handi-Craft Company, St. Louis, MO (US)

(72) Inventors: Bernard J. Kemper, Bonne Terre, MO (US); Charles H. Miller, Barnhart, MO (US)

(21) Appl. No.: 14/881,339

(22) Filed: Oct. 13, 2015

Related U.S. Application Data
(60) Provisional application No. 62/064,718, filed on Oct. 16, 2014.

(51) Int. Cl. A61J 9/04; B65D 1/02

(52) U.S. Cl. CPC A61J 9/04; B65D 1/0246

(57) ABSTRACT

A bottle assembly has an open ended container and a vent assembly positionable at least in part on the rim of the container to permit venting of the container during use. The vent assembly generally comprises a vent insert and a receptacle portion releasably connectable to the vent insert. The vent insert includes an annular lip depending longitudinally within the container upon positioning of the vent assembly on the rim of the container. The annular lip has a transversely inner surface having one of a catch and a latch. The receptacle has a top and a vent tube extending downward from the top. The top of the receptacle includes a transversely outer surface having the opposite one of a catch and a latch, with the top of the receptacle being insertable into the annular lip for releasable latch and catch connection of the receptacle to the vent insert. A collar assembly generally defines a closure for the container, with the collar assembly being configured for releasable engagement with the neck of the container over the open end thereof to retain the vent assembly together with the container.

### CROSS REFERENCE TO RELATED APPLICATIONS

This application claims the benefit of U.S. Provisional Patent Application No. 62/064,718 filed Oct. 16, 2014, the entirety of which is incorporated herein by reference.

### FIELD

The field of this invention relates generally to bottle assemblies and more particularly to a bottle assembly including a collar assembly allowing configuration in at least two different assembled configurations.

### BACKGROUND

Bottle assemblies, such as infant or nursing bottle assemblies, typically have multiple components including a bottle, a nipple, a collar for securing the nipple to the bottle (the nipple and collar sometimes collectively defining a collar assembly), and a cap for covering the nipple when the bottle is not in use. The nipple typically has one or more openings for allowing liquid contained within the bottle to exit through the nipple and into an infant's mouth for consumption by the infant (or young child). During use, the infant places an end of the nipple in their mouth and sucks on the nipple to withdraw the liquid contained within the bottle.

At least some bottle assemblies include a removable vent assembly that can be positioned within the bottle. Some examples of vented bottle assemblies include those available from Handi-Craft Company under the trade name Dr. Brown's. Additional examples are disclosed in U.S. Pat. No. 5,779,071 issued Jul. 14, 1998, U.S. Pat. No. 7,828,165 issued Nov. 9, 2010, U.S. Pat. No. 8,113,365 issued Feb. 14, 2012, and U.S. Pat. No. 8,146,759 issued Apr. 3, 2012, the disclosures of all of which are herein incorporated by reference in their entirety. In these bottle assemblies, the vent assembly allows air to enter the bottle while the infant consumes the liquid through the nipple, thus alleviating or reducing the formation of a vacuum within the bottle during nursing. The vent assembly typically seats, at least in part, on the rim of the bottle and a collar assembly including a collar and nipple are together threadably secured down over the vent assembly to external threads on the neck of the bottle.

Some users may at times assemble such a bottle with the vent assembly omitted from the bottle, such as when traveling or when a child is older and a parent decides to no longer use the vent assembly. In such an instance, the collar assembly is threaded onto the neck of the bottle until the collar is tightened down as much as possible. However, the neck of the bottle and the height of the collar are such that the collar assembly, and in particular the nipple of the collar assembly, do not adequately seal down against the rim of the bottle. As such, leakage of liquid from the bottle can occur.

There is a need, therefore, for a bottle assembly, and in particular a vented bottle assembly, in which the vent assembly can be removed and the bottle assembly still used without the risk of leakage.

### SUMMARY

In one aspect, a bottle assembly generally comprises a container having an open end, a closed end, a base portion, and a neck together defining a liquid chamber within the container. The neck has a rim defining the open end of the container. The container has a central axis. A vent assembly is positionable at least in part on the rim of the container to permit venting of the container during use and generally comprises at least one lateral vent extending other than parallel to the central axis of the container when the vent assembly is positioned on the rim of the container. The vent assembly generally comprises a vent insert and a receptacle portion releasably connectable to the vent insert. The vent insert includes the at least one lateral vent and an annular lip depending longitudinally within the container upon positioning of the vent assembly on the rim of the container. The annular lip has a transversely inner surface, with the inner surface of the annular lip having one of a catch and a latch. The receptacle has a top and a vent tube extending downward from the top. The top of the receptacle includes a transversely outer surface having the opposite one of a catch and a latch, with the top of the receptacle being insertable into the annular lip for releasable latch and catch connection of the receptacle to the vent insert. A collar assembly generally defines a closure for the container, with the collar assembly being configured for releasable engagement with the neck of the container over the open end thereof to retain the vent assembly together with the container.

In another aspect, a bottle assembly generally comprises a container having an open end, a closed end, a base portion, and a neck together defining a liquid chamber within the container, with the neck having a rim defining the open end of the container. The container has a central axis. The neck of the container has a base disposed below the rim of the container and further has a diameter that tapers outward as the neck extends upward from its base to the rim of the container. A vent assembly is positionable at least in part on the rim of the container to permit venting of the container during use and generally comprises at least one lateral vent extending other than parallel to the central axis of the container when the vent assembly is positioned on the rim of the container. The vent assembly further has a container engagement lip extendable longitudinally within the interior space of the container upon positioning of the vent assembly on the rim of the container. The container engagement lip has an annular bulge extending at least in part radially outward therefrom, with the annular bulge being sized for sealing engagement with the neck of the container intermediate the base of the neck and the rim of the container. A collar assembly generally defines a closure for the container, with the collar assembly configured for releasable engagement with the neck of the container over the open end thereof to retain the vent assembly together with the container.

In yet another embodiment, a bottle assembly generally comprises a container having an open end, a closed end, a base portion, and a neck together defining a liquid chamber within the container, with the neck having a rim defining the open end of the container. The container has a central axis. A vent assembly is positionable at least in part on the rim of the container to permit venting of the container during use and generally comprises at least one lateral vent extending other than parallel to the central axis of the container when the vent assembly is positioned on the rim of the container. The vent assembly further has a container engagement lip extendable longitudinally within the interior space of the container upon positioning of the vent assembly on the rim of the container. The container engagement lip has an annular bulge extending at least in part radially outward therefrom, with the annular bulge being sized for sealing engagement with the neck of the container. The container engagement lip further has an annular notch formed therein immediately adjacent the annular bulge. A collar assembly generally defines a closure for the container, with the collar assembly configured for releasable engagement with the neck of the container over the open end thereof to retain the vent assembly together with the container.

In yet another embodiment, a bottle assembly generally comprises a container having an open end, a closed end, a base portion, and a neck together defining a liquid chamber within the container, with the neck having a rim defining the open end of the container. The container has a central axis. A vent assembly is positionable at least in part on the rim of the container to permit venting of the container during use and generally comprises at least one lateral vent extending other than parallel to the central axis of the container when the vent assembly is positioned on the rim of the container. The vent assembly further has a grip tab accessible when the vent assembly is positioned on the rim of the container to facilitate gripping by a user to remove the vent assembly from the container. A collar assembly generally defines a closure for the container, with the collar assembly configured for releasable engagement with the neck of the container over the open end thereof to retain the vent assembly together with the container.

### BRIEF DESCRIPTION OF THE DRAWINGS

FIG. 1 is a perspective cross-section of one embodiment of a nursing bottle assembly including a vent assembly.

FIG. 2 is an enlarged cross-section of a portion of the bottle of FIG. 1 with the vent assembly included.

FIG. 3 is an enlarged cross-section of a portion of the bottle of FIG. 1 with the vent assembly omitted.

FIG. 4 is a cross-section of an enlarged portion of a second embodiment of a nursing bottle assembly.

FIG. 5 is a further an enlarged view of the cross-section of FIG. 4.

FIG. 6 is side elevation of a second embodiment of a nipple suitable for use with the bottle assembly of FIGS. 1-3 or with the bottle assembly of FIGS. 4 and 5.

FIG. 7 is a bottom view of the nipple of FIG. 6.

FIG. 8 is a perspective of third embodiment of a nursing bottle assembly.

FIG. 9 is a perspective of a container of the nursing bottle assembly of FIG. 8.

FIGS. 10A and 10B are perspectives of a nipple of the nursing bottle assembly of FIG. 8.

FIG. 11 is a perspective of a collar of the nursing bottle assembly of FIG. 8.

FIGS. 12A and 12B are perspectives of a vent insert of the nursing bottle assembly of FIG. 8.

FIG. 13 is a perspective of a receptacle portion of a vent assembly of the nursing bottle assembly of FIG. 8.

FIG. 14 is a perspective cross-section of the nursing bottle assembly of FIG. 8 including the vent assembly.

FIG. 15 is an enlarged cross-section of a portion of the nursing bottle assembly of FIG. 8 including the vent assembly.

FIG. 16 is an enlarged cross-section of a portion of the nursing bottle assembly of FIG. 8 with the vent assembly omitted.

FIG. 17 is a perspective cross-section of a fourth embodiment of a nursing bottle assembly including a vent assembly.

FIG. 18A is a perspective view of a nipple suitable for use with the bottle assembly of FIG. 17.

FIG. 18B is a cross-section of the nipple of FIG. 17.

FIG. 19 is a perspective cross-section of a collar suitable for use with the bottle assembly of FIG. 17.

FIG. 20 is a perspective cross-section of a receptacle portion of a vent assembly suitable for use with the bottle assembly of FIG. 17.

FIG. 21A is a perspective view of a vent insert suitable for use with the bottle assembly of FIG. 17.

FIG. 21B is a second perspective view of the vent insert of FIG. 17.

FIG. 21C is a cross-section of the vent insert of FIG. 17.

FIG. 22 is an enlarged cross-section of a portion of the bottle of FIG. 17 with the vent assembly included.

FIG. 23 is an enlarged cross-section of a portion of the bottle of FIG. 17 with the vent assembly omitted.

Corresponding reference characters indicate corresponding parts throughout the several views of the drawings.

### DETAILED DESCRIPTION OF THE DRAWINGS

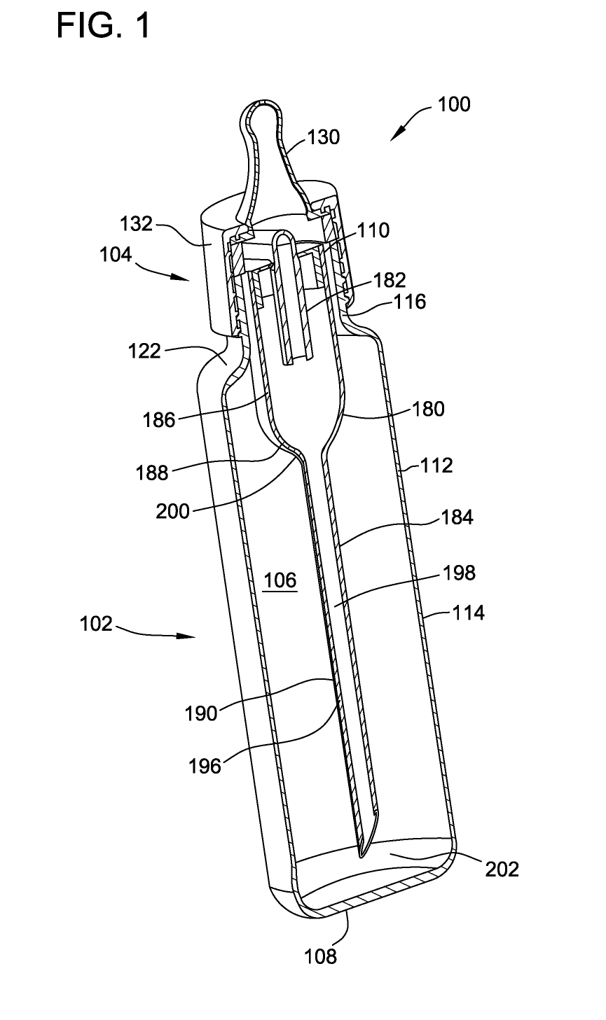

Referring now to the drawings and in particular to FIGS. 1-3, a bottle assembly, generally indicated at 100, includes a container 102 such as bottle and more particularly a nursing bottle in the illustrated embodiment, and a collar assembly, generally indicated at 104 for generally closing the bottle. The container 102 includes a liquid chamber 106 defined therein and adapted to hold a quantity of liquid for consumption by a user, such as a nursing infant. It is also understood that the container 102 may be configured other than as illustrated herein, and may be configured for use other than as a nursing bottle assembly, such as a sports bottle, a drink tumbler, a training cup, a commuter cup, etc. The container 102 may be made of any suitable material such as, without limitation, glass, polypropylene or other plastic, aluminum, or stainless steel. The container 102 can also be made in any desired color or colors, and may be transparent, translucent, or opaque.

The container 102 has a closed bottom 108, an open top 110, and a generally cylindrical side wall 112 extending between the closed bottom 108 and the open top 110. The cylindrical side wall 112 includes a base portion 114 and a neck 116 that is narrowed with respect to the base portion 114. That is, the neck 116 has a smaller diameter than the base portion 114. It is understood that in other embodiments the neck 116 diameter may only be slightly smaller than the diameter of the base portion 114, or even the same diameter as the base portion, without departing from the scope of this invention. The neck 116 includes an annular rim 118, an externally threaded portion 120, and a shoulder 122 defined at the transition between the neck 116 and the base portion 114. The threaded portion 120 includes threads 124 for assembling the container 102 to the collar assembly 104 as described later herein.

The collar assembly 104 of the bottle 100 is adapted for removable attachment to the container 102 for selectively holding a nipple 130 on the container 102. The illustrated collar assembly 104 includes the nipple 130 and a collar 132. The nipple 130 and the collar 132 can each be made of any suitable material. In one embodiment, for example, the nipple 130 is made of a substantially pliable material such as at least one of a rubber material, a silicone material, and a latex material, and the collar 132 is made of polypropylene. The nipple 130 and the collar 132 can be made in any desired color or colors, and may be transparent, translucent, or opaque.

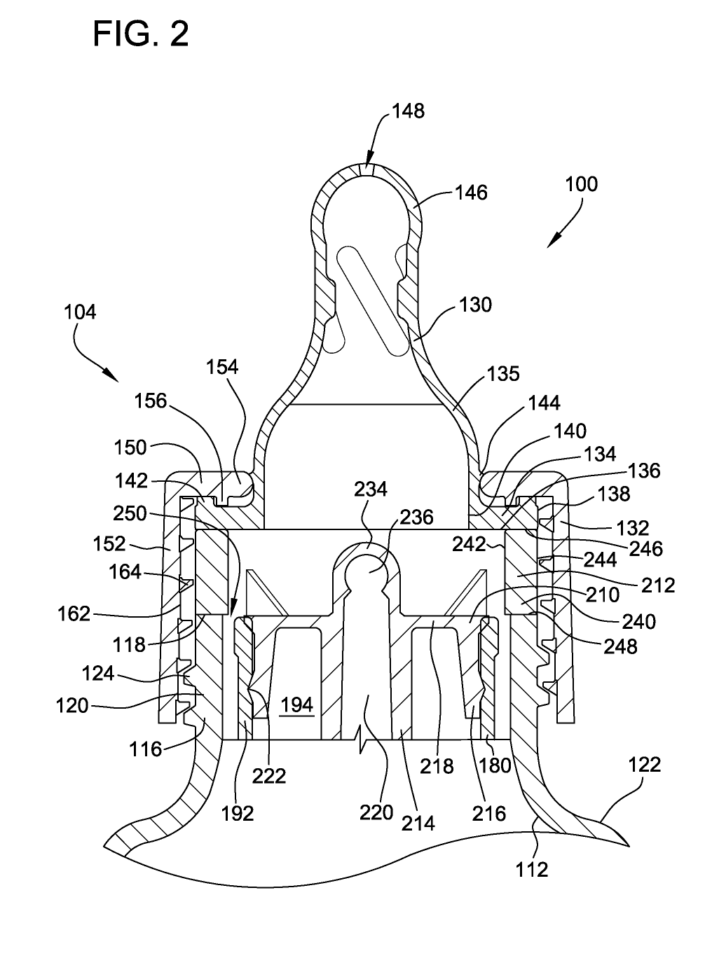

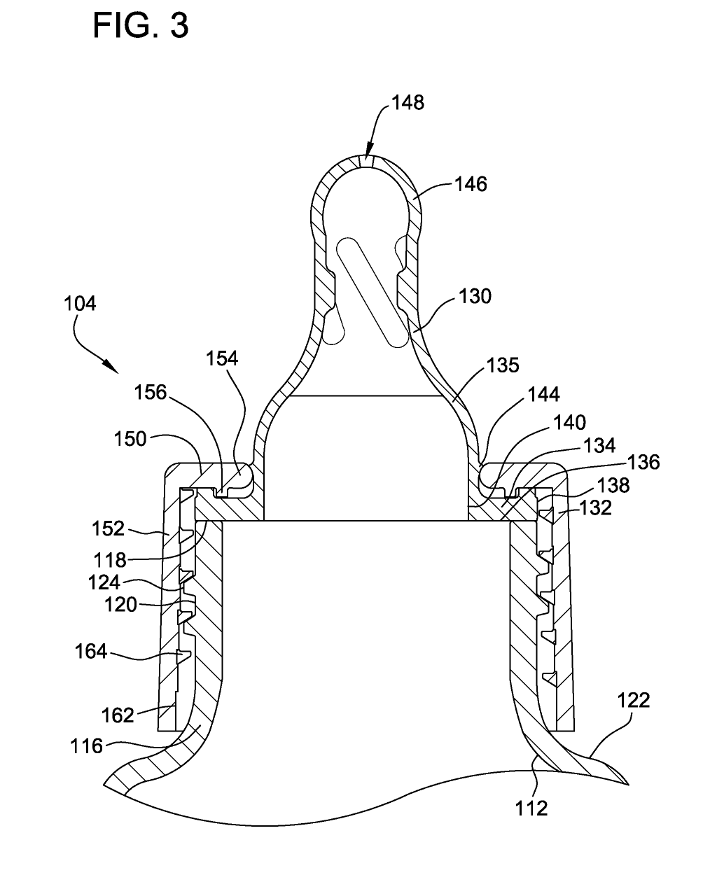

In the illustrated embodiment of FIGS. 2 and 3, the nipple 130 includes a nipple portion 135 and a transversely extending flange 134. The nipple flange 134 includes a bottom face 136 that extends from a generally circular outer edge 138 to a generally circular inner edge 140. In the illustrated embodiment, a peripherally extending lip 142 projects up from the flange generally adjacent the circular outer edge 138. In at least some alternative embodiments, the nipple 130 does not include a peripherally extending lip 142. The nipple portion 135 extends up from the flange 134 generally adjacent the circular inner edge 140 thereof. As illustrated in FIG. 2, the nipple portion 135 includes an annular external projection 144 that projects radially outward. The nipple portion 135 also includes an outlet end 146 including an aperture 148 for dispensing liquid to the user. It is contemplated, however, that the nipple 130 can have different shapes and sizes than those illustrated and described herein without departing from the present invention.

The illustrated collar 132 has an annular top panel 150 and a depending side wall 152. The top panel 150 includes an annular projection 156 that extends downward from the underside of the panel proximate an annular nub or radially inner edge margin 154 of the top panel 150. The edge margin 154 and the annular projection 156 facilitate assembly of the nipple 130 on the collar 132. To assemble the collar assembly 104, the nipple 130 is pulled, nipple portion 135 first, up through the central opening in the top panel 150 of the collar 132 until edge margin 154 is positioned below the annular external projection 144 of the nipple 130, and the annular projection 156 of the collar 132 is positioned radially inward of the peripheral lip 142 of the nipple 130. It is understood, however, that the nipple 130 and collar 132 may be configured other than as illustrated and still otherwise configured for assembly together for further assembly onto the container 102. It is also contemplated that in other embodiments the nipple 130 and collar 132 need not be capable of being held in assembly for conjoint assembly onto the container 102.

The side wall 152 of the collar 132 has an inner surface 162 with suitable internal threads 164 for threaded engagement with the external threads 124 of the neck 116 of the container 102 to releasably secure the collar and hence the collar assembly 104 on the container 102. In one particularly suitable embodiment, as illustrated in FIG. 2, the number of threads 164 on the inner surface 162 of the collar side wall 152 exceeds the number of external threads 124 on the neck 116 of the container, the purpose of which will become apparent. In one embodiment, for example, the collar 132 may have approximately twice as many internal threads 164 as the number of external threads 124 on the neck 116 of the container 102.

With reference to FIGS. 1 and 2, the bottle assembly 100 also includes a vent assembly 180 to permit venting of the bottle assembly during use. In FIG. 3, the vent assembly 180 is omitted. The vent assembly 180, as illustrated in FIG. 1, includes a vent insert 182 and a receptacle portion 184. The receptacle portion 184 is releasably attachable to the vent insert 182, such as by friction fit in a manner known in the art. The receptacle portion 184 includes a top 186, a middle portion 188, and a vent tube 190. The top 186 includes a generally cylindrical side wall 192 that defines a reservoir 194 therein. The vent tube 190 includes a generally cylindrical side wall 196 that has a smaller diameter than the side wall 192 of the top 186. The side wall 196 of the vent tube 190 defines a passage 198 that is in fluid communication with the reservoir 194. The middle portion 188 includes a tapered side wall 200 that extends between the vent tube side wall 196 and the top side wall 192. The vent tube 190 also includes an air outlet 202 at an end of the passage 198 proximate the closed bottom 108 of the container 102.

The vent insert 182 includes an inner portion 210 and an outer portion 212. The inner portion 210 includes an internal vent tube 214, a lip 216, and a top wall 218 extending between and oriented orthogonal to the internal vent tube 214 and lip 216. The internal vent tube 214 defines a passage 220 in flow communication with the reservoir 194. To assemble the vent insert 182 to the receptacle portion 184, the lip 216 is configured to engage the side wall 192 of the receptacle portion 184. For example, in one embodiment, the lip 216 includes a bulge 222 that engages the side wall 192. Alternatively, the vent insert 182 and the receptacle portion 184 may be integrally formed with each other. The inner portion 210 of the vent insert 182 further includes a lateral vent 234 extending upward from the top wall 218 to define a channel 236 within the vent insert 182.

The outer portion 212 of the vent insert 182 includes a perimeter wall 240. The perimeter wall 240 includes an inner edge 242, an outer edge 244, a top 246, and a bottom 248. The perimeter wall 240 has at least one vent (not shown) such that the channel 236 extends through the perimeter wall 240. A gap 250 defined between the perimeter wall 240 and the top wall 218 enables liquid in the liquid chamber 106 to flow towards the nipple 130. It is contemplated, however, that the components of the vent assembly 180 can have different shapes and sizes than those illustrated and described herein without departing from some aspects of this invention. Similar vent assemblies are known in the art, such as those used on the bottle assemblies disclosed in U.S. Pat. No. 5,779,071 issued Jul. 14, 1998, U.S. Pat. No. 7,828,165 issued Nov. 9, 2010, U.S. Pat. No. 8,113,365 issued Feb. 14, 2012, and U.S. Pat. No. 8,146,759 issued Apr. 3, 2012. Accordingly, additional details and operation of the vent assembly 180 is not described further herein.

As illustrated in FIGS. 2 and 3, the collar side wall 152 and the container neck 116 are suitably sized relative to each other to permit operation of the bottle assembly 100 in two different configurations, a first configuration (FIG. 2) in which the vent assembly 180 is included and a second configuration (FIG. 3) in which the vent assembly is omitted. For example, in the illustrated embodiment, the length (or height in the orientation of the drawings herein) of the container neck 116 (e.g., from the rim 118 of the container 102 to the shoulder 122 where the neck widens outward to the base portion 114 of the container) is sufficient to accommodate the side wall 152 of the collar in the second configuration, i.e., when the vent assembly is omitted as illustrated in FIG. 3.

Accordingly, as seen in FIG. 2, in the first configuration, where the bottle assembly 100 includes the vent assembly 180, the vent assembly 180 is inserted into the container 102 such that the bottom 248 of the perimeter wall 240 seats down against the rim 118 of the container. After the vent assembly 180 is inserted within the container 102, the collar assembly 104 is attached to the container 102 by threadably engaging the internal collar threads 164 with the external threads 124 of the neck 116 and rotating the collar 132 to twist the collar down onto the container. As the collar 132 is tightened onto the container 102, the bottom face 136 of the nipple 130 is urged against the top 246 of the perimeter wall 240 of the vent assembly 180 to seal the nipple (and hence the collar assembly 104) against the vent assembly. Concurrently, the bottom 248 of the perimeter wall 240 of the vent assembly is urged against the rim 118 of the container 102 to seal the vent assembly against the container.

In this configuration, some of the lower threads 164 of the collar engage the threads 124 of the neck, while the uppermost collar threads oppose the perimeter wall 240 of the vent assembly. As illustrated in FIG. 2, the collar side wall 152 is sufficiently long such that in the first configuration, the lower end of the collar side wall extends below the lowermost threads 124 of the neck 116 so that no external threads are visible when the collar assembly 104 is secured to the container 102.

In the second configuration, illustrated in FIG. 3, the vent assembly 180 is omitted from the bottle assembly 100. When the collar assembly 104 is tightened down onto the container 102 in this configuration, the collar threads 164 engage the threads 124 of the neck 116 of the container and the collar 132 is rotated to twist the collar down onto the container until the nipple 130 is urged against the rim 118 of the container to seal the nipple directly against the container. In this configuration, a lower set of the collar threads is disposed below the lowermost external thread 124 of the neck 116. In this manner, the lower end of the collar 132 is disposed well below the lowermost external thread 124 and nearer to the shoulder 122 of the container.

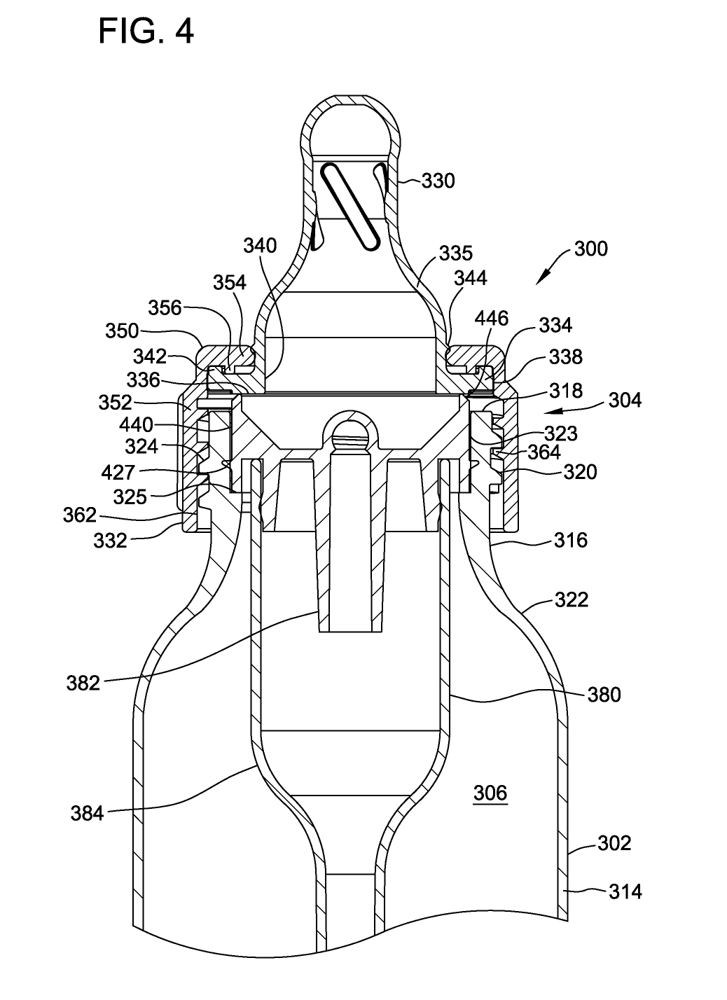

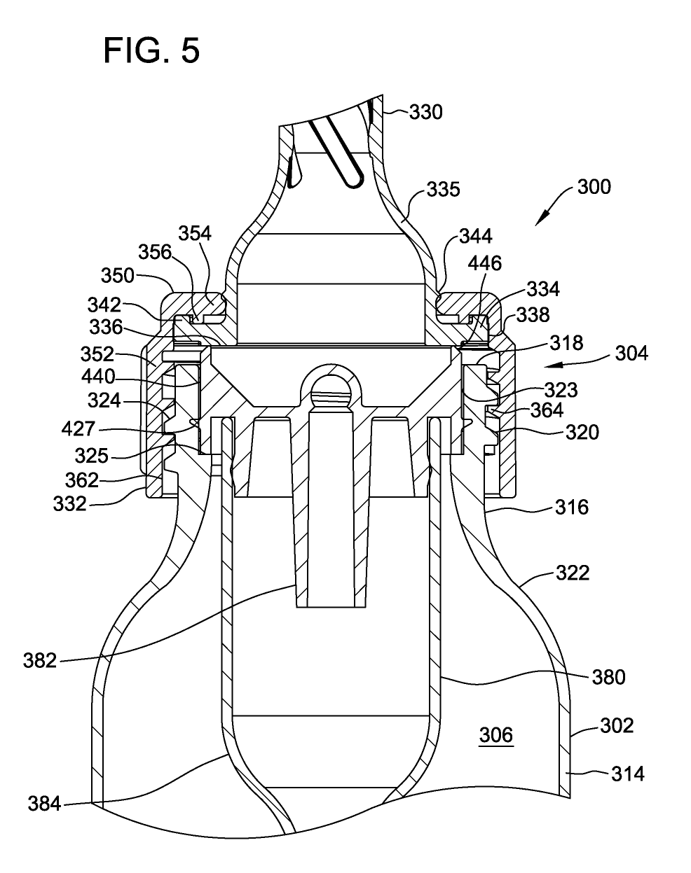

FIGS. 4 and 5 illustrate a second embodiment of a nursing bottle assembly, indicated generally at 300, similar to the nursing bottle assembly 100 of FIGS. 1-3 in that it includes a container 302 comprising a liquid chamber 306, and collar assembly, generally indicated at 304 comprised of a nipple 330 and collar 332 for selectively holding the nipple on the container. The nursing bottle assembly 300 further comprises a vent assembly 380 including a vent insert 382 and receptacle portion 384. The receptacle portion 384 is releasably attachable to the vent insert 382 in the same manner as for the vent assembly 180 of the embodiment of FIGS. 1-3. In this embodiment, however, substantially the entire vent assembly 380 and in particular the vent insert 382 is disposed substantially entirely within the liquid chamber 306 of the container 302 (e.g., in the neck 316 of the container).

As illustrated in FIGS. 4 and 5, the neck 316 of the container 302 includes an annular rim 318, an externally threaded portion 320, and an external shoulder 322 defining a transition between the neck 316 and a base portion 314 of the container. The threaded portion 320 includes threads 324 for assembling the container 302 to the collar assembly 304. An inner surface 323 of the neck 316 of the container 302 has a stepped inner diameter that defines an inner shoulder 325 for supporting the vent insert 382 within the neck of the container.

The nipple 330 includes a nipple portion 335 and a transversely extending flange 334 having a bottom face 336 that extends from a generally circular outer edge 338 to a generally circular inner edge 340. In the illustrated embodiment, a peripherally extending lip 342 projects up from the flange 334 generally adjacent the circular outer edge 338. In at least some alternative embodiments, the nipple 330 does not include a peripherally extending lip 342. The nipple portion 335 extends up from the flange 334 generally adjacent the circular inner edge 340 thereof. As illustrated in FIG. 4, the nipple portion 335 includes an annular external projection 344 that projects radially outward. It is contemplated, however, that the nipple 330 can have different shapes and sizes than those illustrated and described herein without departing from the present invention.

The illustrated collar 332 has an annular top panel 350 and a depending side wall 352. The top panel 350 includes an annular projection 356 that extends downward from the underside of the top panel proximate an annular nub or radially inner edge margin 354 of the top panel 350. The edge margin 354 and the annular projection 356 facilitate assembly of the nipple 330 on the collar 332. To assemble the collar assembly 304, the nipple 330 is pulled, nipple portion 335 first, up through the central opening in the top panel 350 of the collar 332 until the edge margin 354 is positioned below the annular external projection 344 of the nipple 330, and the annular projection 356 of the collar 332 is positioned radially inward of the peripheral lip 342 of the nipple 330. It is understood, however, that the nipple 330 and collar 332 may be configured other than as illustrated and still otherwise configured for assembly together for further assembly onto the container 302. It is also contemplated that in other embodiments the nipple 330 and collar 332 need not be capable of being held in assembly for conjoint assembly onto the container 302.

The side wall 352 of the collar 332 has an inner surface 362 with suitable internal threads 364 for threaded engagement with the external threads 324 of the neck 316 of the container 302 to releasably secure the collar 332 and hence the collar assembly 304 to the container 302.

The vent insert 382 of the vent assembly 380 includes a perimeter wall 440 having an annular bulge 427 that sealingly engages the inner surface 323 of the neck 316 of the container 302 just above the inner shoulder 325. It is understood that in other embodiments the annular bulge 427 may be located on the perimeter wall 440 of the vent insert 382 to sealingly engage the inner surface 323 of the neck 316 at a position spaced further above the inner shoulder 325 without departing from the scope of this invention.

The perimeter wall 440 of the vent insert 382 is suitably long enough (e.g., in height in the orientation of FIGS. 4 and 5) such that when the vent insert 382 is seated on the inner shoulder 325 of the neck 316 of the container 302, a top 446 of the vent insert 382 extends sufficiently above the rim 318 of the container 302 so as to engage the nipple 330 upon assembly of the nursing bottle assembly 300. The top 446 of the vent insert 382 also holds the nipple 330 high enough to prevent the nipple from forming an airtight seal against the rim 318 of the container 302.

By configuring the vent assembly 380 and more particularly the vent insert 382 to be disposed substantially entirely within the liquid chamber 306 of the container 302, no bottle-specific nipple 330 and collar 332 are needed. For example, in the illustrated embodiment of FIGS. 4 and 5, upon assembly of the nursing bottle assembly 300 in a first configuration in which the vent insert 382 is used, the vent insert (with the receptacle portion 384 attached thereto) is disposed in the container 302 with the vent insert seated on the inner shoulder 325 of the inner surface 323 of the container. The collar assembly 304 (i.e., the nipple 330 and collar 332) is attached to the container 302 by threadably engaging the collar with the external threads 324 of the neck 316 of the container and rotating the collar to twist the collar down onto the container. As the collar 332 is tightened onto the container 302, the bottom face 336 of the nipple 330 seals against the top 446 of the perimeter wall 440 of the vent insert while allowing air to enter the container between the nipple and the rim 318 of the container.

In a second configuration (not shown) of the nursing bottle assembly 300, the vent assembly 380 is omitted. But in this embodiment the collar assembly 304 is attached to the container 302 in the same manner as in the first configuration. Accordingly, the collar 332 of this second embodiment need not be configured to fit on the container differently in the second configuration than in the first configuration.

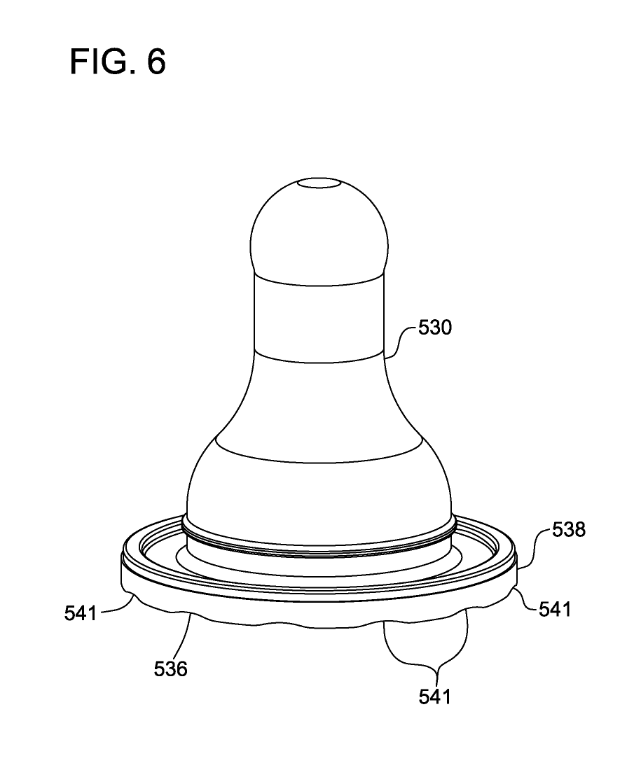

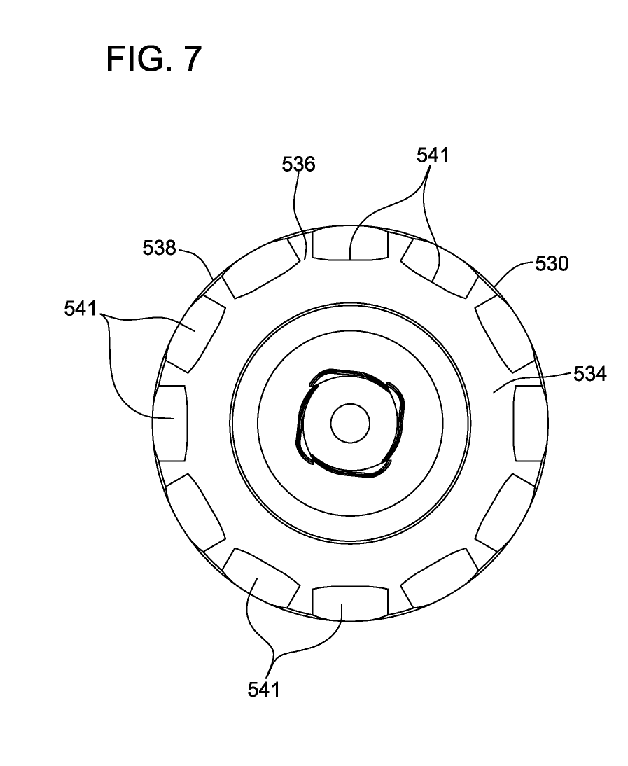

FIGS. 6 and 7 illustrate a second embodiment of a suitable nipple 530 for use with the nursing bottle assemblies 100, 300 of the first and second embodiments herein. The nipple 530 is similar to the nipple 130 of FIGS. 1-3 and the nipple 330 of FIGS. 4 and 5, with the exception of the configuration of the bottom face 536. In this embodiment, a bottom face 536 of the nipple 530 has a plurality of vent features 541 extending radially inward from an outer edge margin 538 of the flange 534 of the nipple 530 in equal, circumferentially spaced relationship with each other. As best seen in FIG. 7, the illustrated vent features 541 comprise a plurality of arcuate (in circumferential extension) channels that extend radially inward from the outer edge margin 538 of the nipple flange 534. It is understood that in other embodiments the vent features 541 may be configured to have any other suitable shape. It is also contemplated that the vent features 541 may instead comprises radially extending slits formed in the bottom face 536 of the nipple 530.

The vent features 541 are suitably sized in length (e.g., in the radial direction), such that when the nipple 530 is used in the nursing bottle assembly 100 of the embodiment of FIGS. 1-3, the vent features 541 do not extend radially inward of the vent insert 182 in the first configuration of the bottle assembly (e.g., with the vent assembly 180 in place) so that the vent insert 182 seals against the bottom face 536 of the nipple 130 radially inward of the vent features 541. But in the second configuration of the bottle assembly 100 the bottom face 536 of the nipple 530 contacts the rim 118 of the container 102 with the vent features 541 extending radially inward of the rim 118 of the container 102 so that air can still enter the container 102 via the vent features 118.

Likewise, in the nursing bottle assembly 300 of FIGS. 4 and 5, in the first configuration of the bottle assembly (with the vent assembly 380 in place) the top 446 of the perimeter wall 440 of the vent insert 382 seals against the bottom face 536 of the nipple radially inward of the vent features 541 (e.g., so that air enters the container 302 only through the vent assembly 380). In the second configuration of the bottle assembly 300 the bottom face 536 of the nipple 530 contacts the rim 318 of the container 302 with the vent features 541 extending radially inward of the rim 318 of the container 302 so that air can still enter the container 302 via the vent features 541.

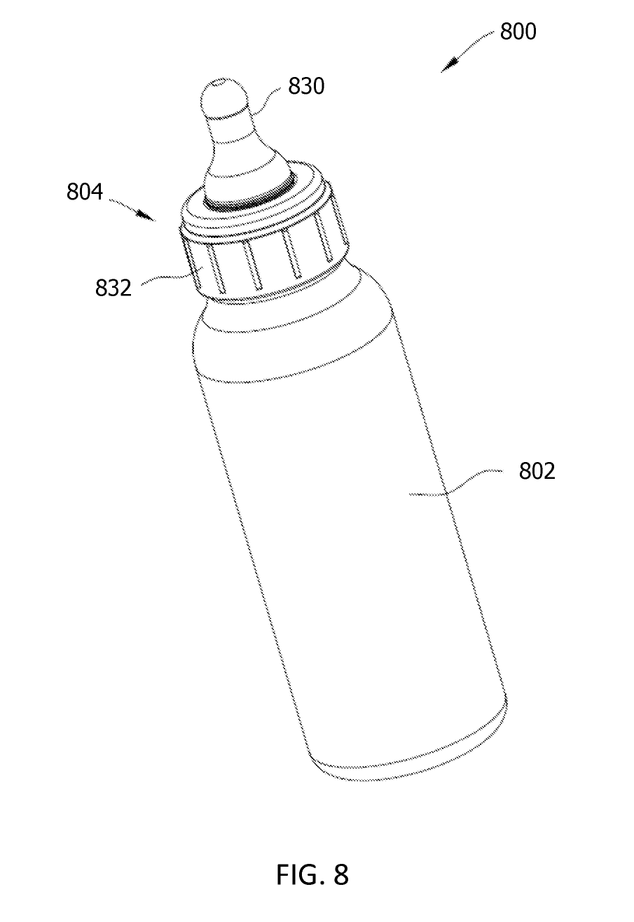

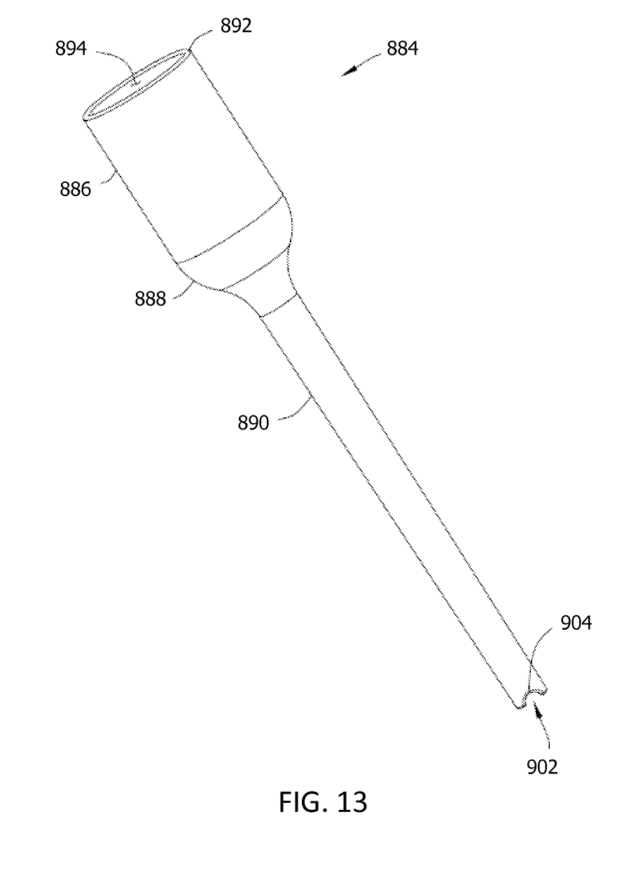

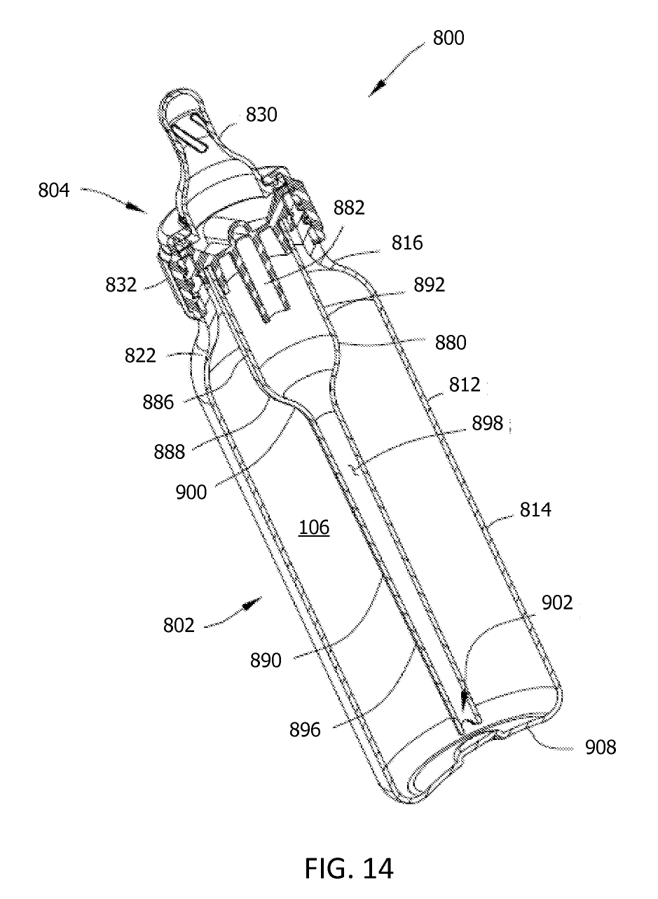

FIGS. 8-16 illustrate a third embodiment of a dual configuration bottle assembly. The bottle assembly, generally indicated at 800, is similar to the bottle assembly 100 of FIGS. 1-3. The bottle assembly 800 includes a container 802 such as a bottle and more particularly a nursing bottle in the illustrated embodiment, and a collar assembly, generally indicated at 804, for generally closing the bottle. The container 802 is generally cylindrical and symmetric about a central axis, and includes a liquid chamber 806 defined therein and adapted to hold a quantity of liquid for consumption by a user, such as a nursing infant. It is also understood that the container 802 may be configured other than as illustrated herein, and may be configured for use other than as a nursing bottle assembly, such as a sports bottle, a drink tumbler, a training cup, a commuter cup, etc. The container 802 may be made of any suitable material such as, without limitation, glass, polypropylene or other plastic, aluminum, or stainless steel. The container 802 can also be made in any desired color or colors, and may be transparent, translucent, or opaque.

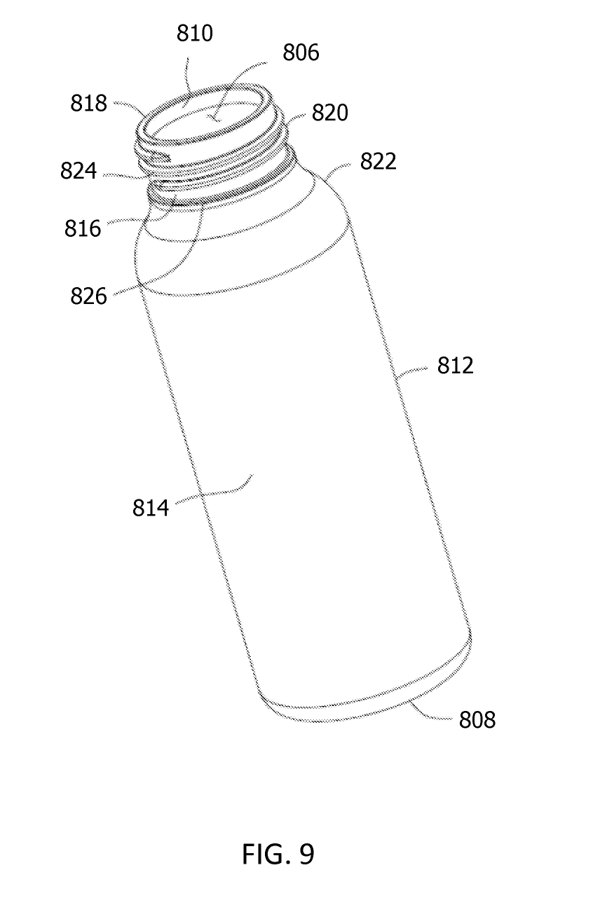

The container 802 is similar to the container 102 of FIG. 1, with the exception of the configuration of an open top 810 of the container 802. In this embodiment, the container 802, as most readily seen in FIG. 9, has a closed bottom 808, an open top 810, and a generally cylindrical side wall 812 extending between the closed bottom 808 and the open top 810. The cylindrical side wall 812 includes a base portion 814 and a neck 816 that is narrowed with respect to the base portion 814. That is, the neck 816 has a smaller diameter than the base portion 814. The neck 816 includes an annular rim 818, an externally threaded portion 820, and a lip 826 extending around the circumference of the neck 816. When assembled, the lip 826 may be located proximate a bottom edge 851 of a collar 832 (to be discussed more fully). The container 802 further comprises a shoulder 822 defined at the transition between the neck 816 and the base portion 814. The threaded portion 820 of the neck 816 includes threads 824 for assembling the container 802 to the collar assembly 804 as described later herein.

The collar assembly 804 of the bottle 800 is adapted for removable attachment to the container 802 for selectively holding a nipple 830 on the container 802. The illustrated collar assembly 804 includes the nipple 830 and a collar 832. The nipple 830 and the collar 832 can each be made of any suitable material. In one embodiment, for example, the nipple 830 is made of a substantially pliable material such as at least one of a rubber material, a silicone material, and a latex material, and the collar 832 is made of polypropylene. The nipple 830 and the collar 832 can be made in any desired color or colors, and may be transparent, translucent, or opaque.

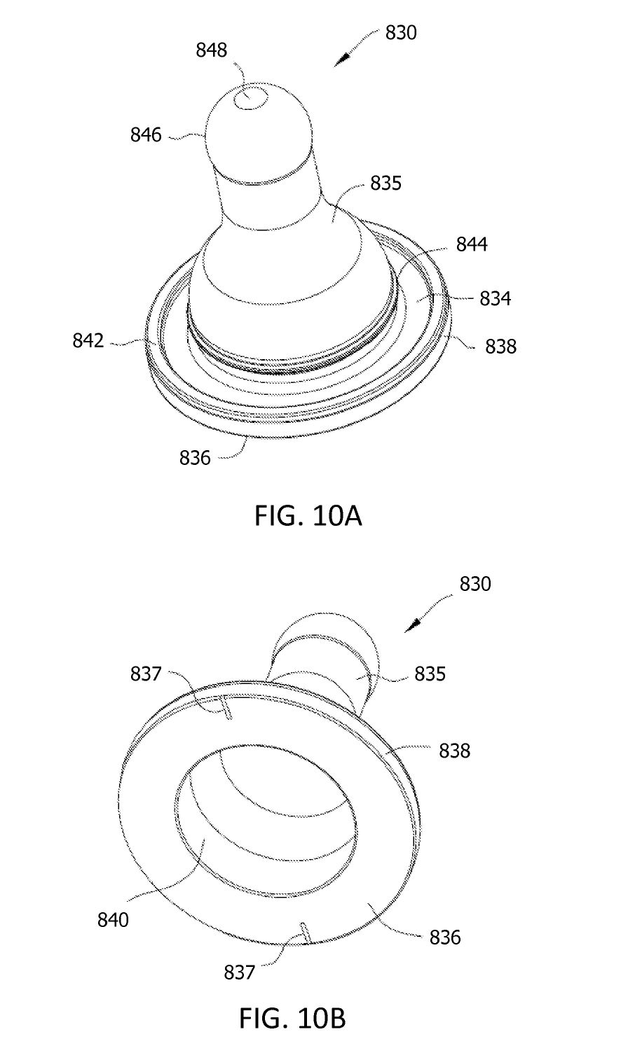

As best seen in FIGS. 10A and 10B, the nipple 830 is similar to the nipple 130 of FIG. 1-3, with the exception of the bottom face 836. In this embodiment, the nipple 830 includes a nipple portion 835 and a transversely extending flange 834. The nipple flange 834 includes a bottom face 836 that extends from a generally circular outer edge 838 to a generally circular inner edge 840. In the illustrated embodiment, a peripherally extending lip 842 projects up from the flange 834 generally adjacent the circular outer edge 838. In at least some alternative embodiments, the nipple 830 does not include a peripherally extending lip 842. The nipple portion 835 extends up from the flange 834 generally adjacent the circular inner edge 840 thereof. In some embodiments, the nipple portion 835 includes an annular projection 844 that projects radially outward. The nipple portion 835 also includes an outlet end 846 including an aperture 848 for dispensing liquid to the user. In some embodiments, In this embodiment, the nipple 830 may include one or more radially extending grooves 837 provided on the bottom face 836 of the nipple flange 834. The one or more grooves 837 may facilitate venting of the bottle assembly 800 when the bottle assembly 800 is used without the vent assembly 880, as will be more fully discussed. It is contemplated, however, that the nipple 830 can have different shapes and sizes than those illustrated and described herein without departing from the present invention.

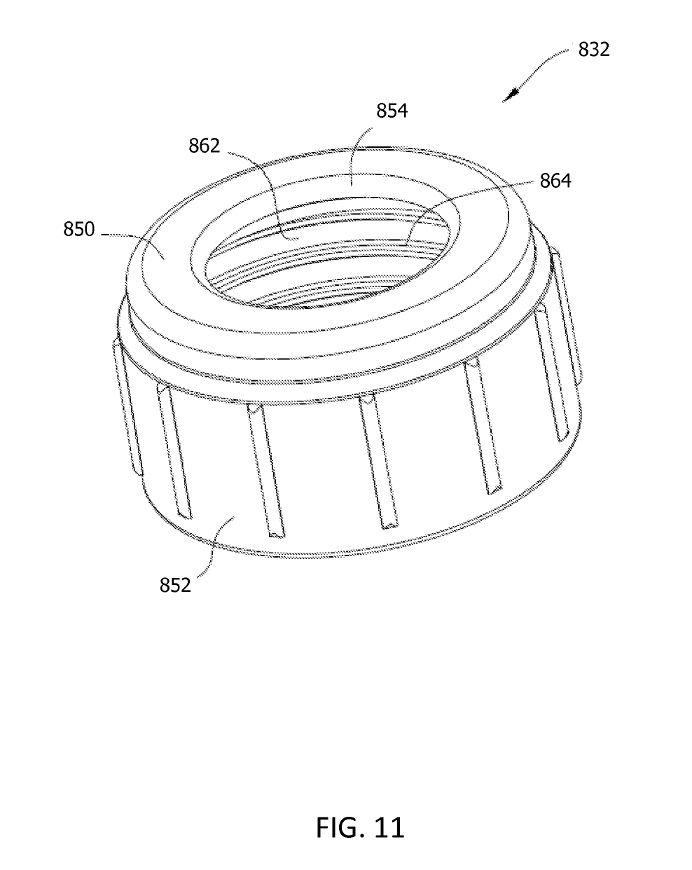

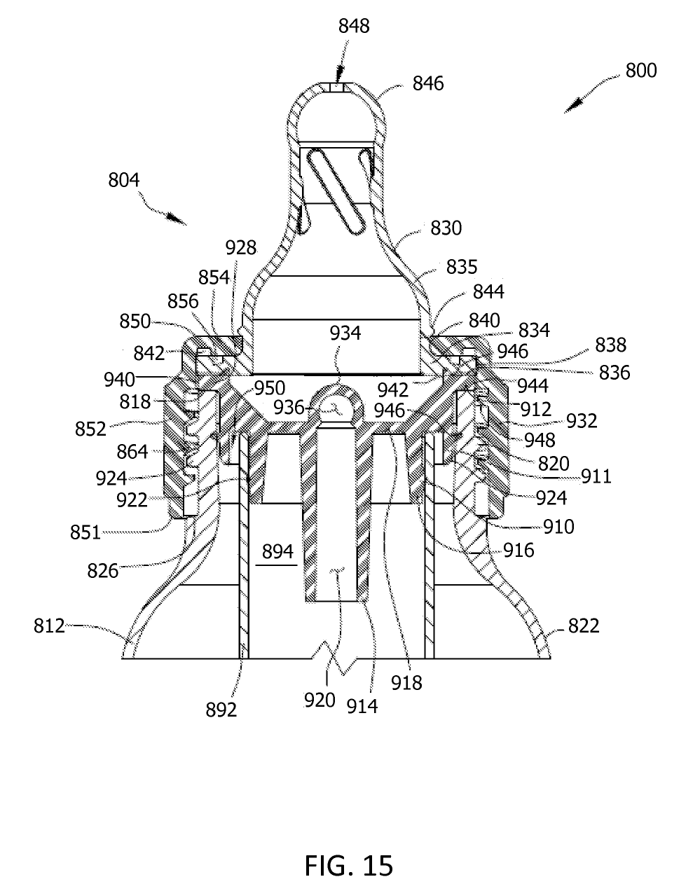

As best seen in FIG. 11, the illustrated collar 832 has an annular top panel 850 and a depending side wall 852. The top panel 850 includes an annular projection 856 (as seen in FIG. 15) that extends downward from the underside of the panel proximate a radially inner edge margin 854 of the top panel 850. The edge margin 854 and the annular projection 856 facilitate assembly of the nipple 830 on the collar 832. To assemble the collar assembly 804, the nipple 830 is pulled, nipple portion 835 first, up through the central opening in the top panel 850 of the collar 832 until edge margin 854 is positioned below the annular projection 844 of the nipple 830, and the annular projection 856 of the collar 832 is positioned radially inward of the peripheral lip 842 of the nipple 830. It is understood, however, that the nipple 830 and collar 832 may be configured other than as illustrated and still otherwise configured for assembly together for further assembly onto the container 802. It is also contemplated that in other embodiments the nipple 830 and collar 832 need not be capable of being held in assembly for conjoint assembly onto the container 802.

The side wall 852 of the collar 832 has an inner surface 862 with suitable internal threads 864 for threaded engagement with the external threads 824 of the neck 816 of the container 802 to releasably secure the collar 832 and hence the collar assembly 804 on the container 802.

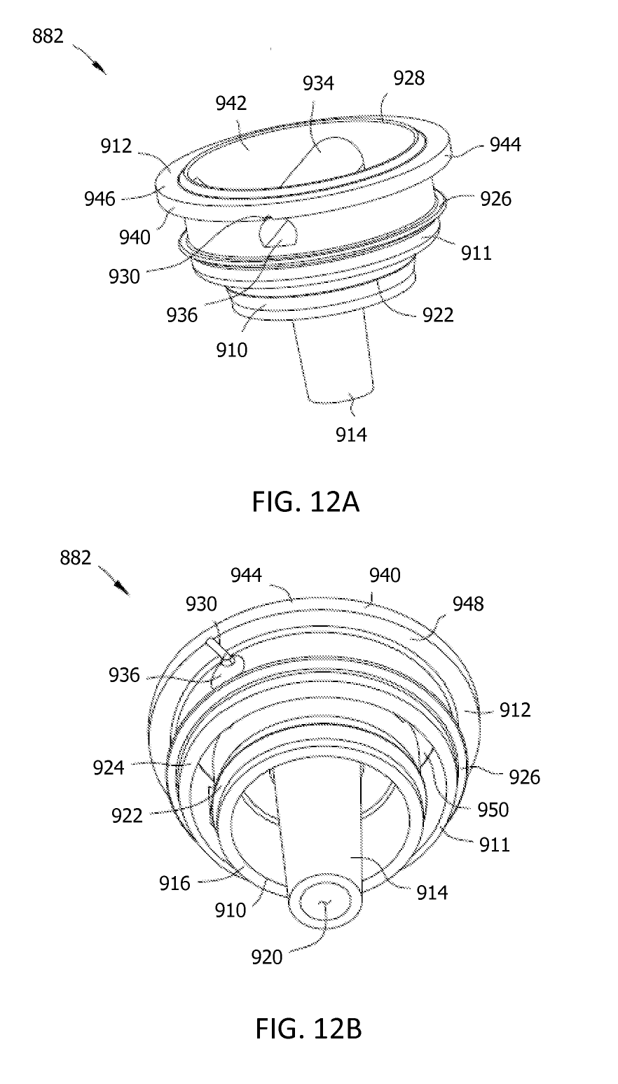

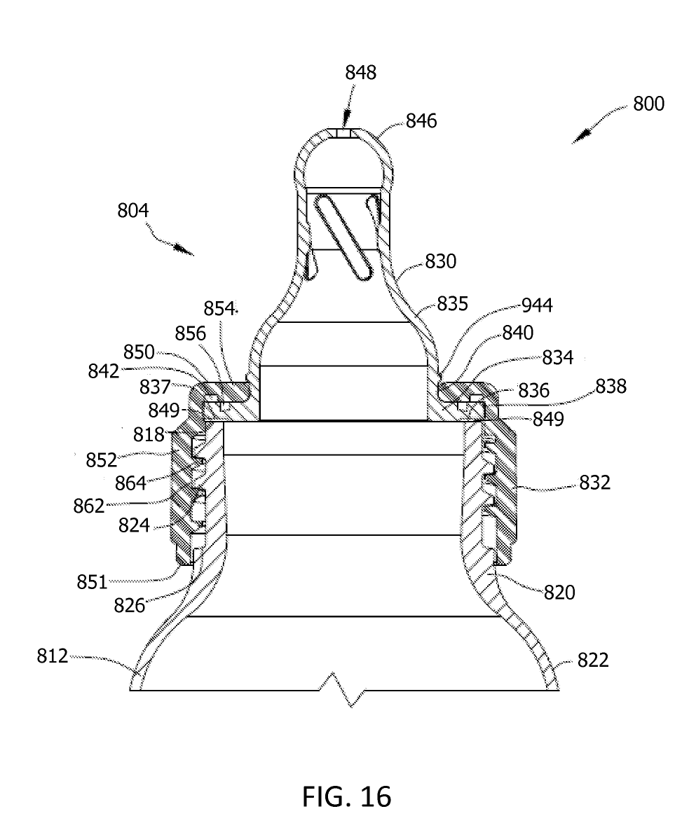

As best seen in FIGS. 12A-15, the bottle assembly 800 also includes a vent assembly 880 to permit venting of the bottle assembly during use. In FIG. 16, the vent assembly 880 is omitted. The vent assembly 880 is similar to the vent assembly 180, of FIGS. 1-3, with the exception of the air outlet. In this embodiment, the vent assembly 880 includes a vent insert 882 and a receptacle portion 884. The receptacle portion 884 is releasably attachable to the vent insert 882, such as by friction fit in a manner known in the art. The receptacle portion 884 includes a top 886, a middle portion 888, and a vent tube 890. The top 886 includes a generally cylindrical side wall 892 that defines a reservoir 894 therein. The vent tube 890 includes a generally cylindrical side wall 896 that has a smaller diameter than the side wall 892 of the top 886. The side wall 896 of the vent tube 890 defines a passage 898 that is in fluid communication with the reservoir 894. The middle portion 888 includes a tapered side wall 900 that extends between the vent tube side wall 896 and the top side wall 892. The vent tube 890 also includes an air outlet 902 at an end of the passage 898 proximate the closed bottom 808 of the container 802. The air outlet 902 of vent tube 890 may comprise one or more notches 904 to assist the flow of air and/or fluid from within the passage 898 to the liquid chamber 806 of the container 802.

As best seen in FIGS. 12A-12B and 15, the vent insert 882 is similar to the vent insert 182 of FIGS. 1 and 2 and vent insert 382 of FIGS. 4 and 5, with the exception that the vent insert 882 includes an inner portion 910, an intermediate portion 911, and an outer portion 912. The inner portion 910 includes an internal vent tube 914, a lip 916, and a top wall 918 extending between and oriented normal to the internal vent tube 914 and lip 916. The internal vent tube 914 defines a passage 920 in flow communication with the reservoir 894. To assemble the vent insert 882 to the receptacle portion 884, the lip 916 is configured to engage the side wall 892 of the receptacle portion 884. For example, in one embodiment, the lip 916 includes a bulge 922 that engages the side wall 892. Alternatively, the vent insert 882 and the receptacle portion 884 may be integrally formed with each other. The inner portion 910 of the vent insert 882 further includes a lateral vent 934 extending upward from the top wall 918 to define a channel 936 within the vent insert 882.

The intermediate portion 911 of the vent insert 882 is positioned radially between the inner portion 910 and the outer portion 912 with respect to a center of the vent insert 882. The intermediate portion 911 includes a container engaging lip 924 configured to abut an inner surface of the side wall 812 of the container 802, with a container engaging bulge 926 disposed on the container engaging lip 924. The container engaging bulge 926 may frictionally engage the inner surface of the side wall 912 of the container 802 (more particularly, an inner surface of the neck 816 of the container 802) when the vent assembly 880 is seated on container 802. A gap 950 defined between the side wall 892 of the receptacle portion 884 and the container engaging lip 924 enables liquid in the liquid chamber 806 to flow towards the nipple 830.

The outer portion 912 of the vent insert 882 includes a perimeter wall 940. The perimeter wall 940 includes an inner edge 942, an outer edge 944, a top 946, and a bottom 948. The bottom 948 of the perimeter wall 940 is configured to sit on the annular rim 818 of the container 802 when the bottle assembly 800 is assembled, as best seen in FIG. 15. The outer portion 912 may further comprise an annular rib 928 projecting from the top 946 of the perimeter wall 940. The annular rib 928 may serve to compress and/or deform the flange 834 of the nipple 830 when the collar assembly 804 is attached to the container 802 in order to reduce leakage during use of the bottle assembly 800. The annular rib 928 may also sealingly engage the bottom face 836 of the nipple 830 in a configuration in which the bottle assembly 880 includes the vent assembly 880. Outer portion 912 may further comprise one or more radially extending grooves 930 provided on the bottom 948 of the perimeter wall 940 which are in fluid communication with the channel 936 of the lateral vent 934. In such embodiments, the one or more grooves 930 space a portion of the vent insert 882 apart from the rim 818 of the container 802 to allow air to flow to the lateral vent 934 when the outer portion 912 is pressed against the rim 818. Thus, the lateral vent 936 will be in fluid communication with an exterior of the bottle assembly 800 via the one or more grooves 930 when the bottle assembly 800 includes the vent assembly 880 such that the container 802 can vent during use of the bottle assembly 800.

Although the vent assembly 880 depicted in the figures has been described in detail, it is contemplated that the components of the vent assembly 880 can have different shapes and sizes than those illustrated and described herein without departing from some aspects of this disclosure.

As best illustrated in FIGS. 15 and 16, the collar sidewall 852, the outer portion 912 of the vent insert 882, and the container neck 816 are suitably sized relative to each other to permit operation of the bottle assembly 800 in two different configurations: a first configuration (as seen in FIG. 15) in which the vent assembly 880 is included and a second configuration (as seen in FIG. 16) in which the vent assembly 880 is omitted. For example, the length (or height in the orientation of the drawings herein) of the container neck 816 (e.g., from the rim 818 of the container 802 to the lip 826 and/or to the shoulder 822 where the neck 816 widens outward to the base portion 814 of the container 802) is sufficient to accommodate the side wall 852 of the collar 832 in the second configuration; i.e., when the vent assembly is omitted as illustrated in FIG. 16. More particularly, when the vent assembly 880 is omitted, the collar 832 is configured to tighten down an additional vertical distance approximately equal to a height of the perimeter wall 940 of the outer portion 912 of the vent insert 882 such that the bottom face 836 of the nipple 830 seats on the annular rim 818 of the container 802. In such an embodiment, because the collar 832 is configured to tighten down the additional vertical distance, the collar 832 can securely seat the nipple 830 to the annular rim 818 in order to minimize or even eliminate leakage of liquid from the bottle assembly 800 when used without the vent assembly 880.

This may be more readily understood with reference to FIGS. 12A-12B and 15. As illustrated, the vent insert 882 is constructed such that the height of the outer portion 912 (more specifically, the height of the perimeter wall 940) is relatively narrow compared to the rest of the vent insert 882. This is achieved by, among other features, providing the channel 936 of the lateral vent 934 below the outer portion 912 such that the channel 936 (or, alternatively, a majority of the channel 936) ultimately sits below the annular rim 818 of the container 802 when the vent insert 882 is in the assembled position (as depicted in FIG. 15). Accordingly, the height of the perimeter wall 940 of the outer portion 912 may be narrower than otherwise would be necessary to accommodate the channel 936 of the lateral vent 934 if the channel 936 was provided above the annular rim 818 of the container 802 when assembled (as is common for many known vent assemblies). Rather, the perimeter wall 940 of the vent insert 882 must only be tall enough to accommodate the one or more grooves 930, which is in fluid communication with the channel 936 of the lateral vent 834.

Such relative dimensions of the vent insert (i.e., the narrowness of the perimeter wall 940 relative to the other features of vent insert 882) allows the bottle assembly 800 to be assembled in two configurations while minimizing leakage from the bottle assembly 800 in each configuration. For example, and as best seen in FIG. 15, in a first configuration, the bottle assembly 800 includes the vent assembly 880. In this configuration, the vent assembly 880 is inserted into the container 802 such that the bottom 948 of the perimeter wall 940 of the vent insert 882 seats down against the rim 818 of the container 802, and such that the container engaging lip 924 (or more particularly the container engaging bulge 926) frictionally engages an inner surface of the side wall 812 of the container 802. After the vent assembly 880 is inserted in such a position, the collar assembly 804 is attached to the container 802 by threadably engaging the internal collar threads 864 with the external threads 824 of the neck 816 and rotating the collar 832 to twist the collar down onto the container 802. As the collar 832 is tightened onto the container 802, the bottom face 836 of the nipple 830 is urged against the top 946 of the perimeter wall 940 and against the annular rib 928 of the vent insert 882 to seal the nipple 830 (and hence the collar assembly 804) against the vent assembly 880. Concurrently, the bottom 948 of the perimeter wall 940 of the vent insert 882 is urged against the rim 818 of the container 802 to position the vent assembly 880 on the container 802.

In this configuration, the collar threads 864 engage the threads 824 of the neck such that no threads are visible below the collar 832. More particularly, and as best illustrated in FIG. 15, the collar side wall 852 is sufficiently long such that in the first configuration, the bottom edge 851 of the collar side wall 852 extends below the lowermost external thread 824 of the neck 816 so that no external threads 824 are visible when the collar assembly 804 is secured to the container 802. Further, because the collar assembly 804 securely seats the nipple 830 and the vent assembly 880 to the rim 818 of the container 802, leakage is minimized during use of the bottle assembly 800.

Further, in embodiments where the nipple 830 includes one or more radially extending grooves 837 on the bottom face 836 of the flange 834, the annular rib 928 provided on the vent insert 882 may serve as a seal between the one or more grooves 837 and the liquid chamber 806 of the container 802 such that the one or more grooves 837 are not in fluid communication with the liquid chamber 806 when the bottle assembly 800 is in the first configuration. More particularly, and returning to FIG. 10B, the one or more grooves 837 provided on the bottom face 836 of the nipple flange 834 may extend only partially in from the outer edge 838 of the nipple 830 (i.e., the one or more grooves 837 may not extend all the way to an inner edge 840 of the nipple 830). Further, the annular rib 928 of the vent insert 882 may be disposed (when the bottle assembly 800 is assembled in the first configuration) radially inward from the innermost portion of the one or more grooves 837. In such an embodiment, because the annular rib 928 is disposed radially inward from the innermost portion of the one or more grooves 837, the annular rib 928 may seal the liquid chamber 806 of the container 802 from the one or more grooves 837, such that the one or more grooves 837 are not in fluid communication with the liquid chamber 806 when the bottle assembly 800 is in the first configuration. In such embodiments, venting of the container 802 during use may be accomplished via the vent assembly 880, and, more particularly, via the one or more grooves 930 and the lateral vent 934 of the vent insert 882.

In a second configuration, as illustrated in FIG. 16, the vent assembly 880 is omitted from the bottle assembly 800. In such a configuration, when the collar assembly 804 is tightened down onto the container 802, the collar threads 864 engage the threads 824 of the neck 816 of the container 802 and the collar 832 is rotated to twist the collar 832 down onto the container 802 until the nipple 830 is urged against the rim 818 of the container 802 to seal the nipple 830 directly against the container 802. Accordingly, the collar assembly 804 will ultimately be twisted a greater distance than in the first configuration before it is fully seated on the container 802. That is, because the vent assembly 880 (and accordingly the vent insert 882) is omitted from the bottle assembly 800 in this configuration, the collar assembly 804 will need to be tightened down an additional vertical distance approximately equal to the height of perimeter wall 940 of the omitted vent inset 882. However, because the vent insert 882 is constructed as described (e.g., because the channel 936 of the lateral vent 934 is disposed below the outer portion 912 of the vent insert 882), the perimeter wall 940 is relatively narrow and thus the collar 832 does not require much additional tightening than when the vent assembly 880 is included (as depicted in FIG. 15). Accordingly, in the second configuration, the collar assembly 804 can be fully tightened (i.e., fully assembled such that the nipple 830 securely engages the container 802) before the side wall 852 of the collar 832 engages with the lip 826 and/or the shoulder 822.

The one or more grooves 837 included on the bottom face 836 of the nipple 830 may be configured to vent the container 802 when the bottle assembly 800 is in the second configuration even though the vent assembly 880 is omitted. More particularly, and as best seen in FIG. 16, the one or more grooves 837 space a portion of the nipple 830 apart from the rim 818 of the container 802 forming vent spacing 849 which is in fluid communication with the liquid chamber 806 of the container 802. Thus, when the bottle assembly 800 is assembled in the second configuration (i.e., when the bottle assembly 800 is used with the vent assembly 880 omitted with the nipple 830 pressed against the rim 818), the bottle assembly 800 may nonetheless vent through the vent spacing 849 provided between the one or more grooves 837 and the rim 818 of the container. Thus, even in the second configuration, the formation of a vacuum within the bottle assembly 800 can be reduced or eliminated, as air may fluidly enter the bottle assembly via vent spacing 849.

The components as described herein may provide additional benefits for users of existing bottle assemblies and/or existing vent assemblies. For example, many current users may already own several containers 802 configured to operate with one or more of the known collar assemblies and/or vent assemblies. These containers may comprise, e.g., a lip 826 and/or external threads 824 configured to be used with a known collar assembly and/or a known vent assembly. However, because the perimeter wall 940 of the vent insert 882 is constructed as described herein (i.e., the perimeter wall 940 is relatively narrow as compared to prior art vent insert) the side wall 852 of the collar 832 may be constructed narrower than, e.g., known collars, while still covering the external threads 824 of the container 802 when assembled with the vent assembly 880 (as discussed). Accordingly, a user may be able to use the collar assembly 804 and/or the vent assembly 880 described herein with their currently owned containers 802, whereas the lip 826 and/or shoulder 822 would otherwise interfere with a known collar (thus leading to leakage) should the known vent assembly be omitted. Further, because some embodiments of the collar assembly 804 of the instant disclosure (and more particularly some embodiments of the nipple 830 of the instant disclosure) include one or more grooves 837 which provide the vent spacing 849 when the bottle assembly 800 is in the second configuration, the container 802 may be vented during use even if the vent assembly 880 is omitted. Thus, some embodiments of the instant disclosure reduce or eliminate the formation of a vacuum within the bottle assembly 800 during use even if the vent assembly 880 is omitted. Still further, a manufacturer or the like of the containers 802 may continue to manufacture the containers 802 using a same design as for known bottle assemblies, while providing the bottle assemblies 800 with the novel collar assembly 804 and/or vent assembly 880 described herein such that the improved bottle assembly 800 reduces or eliminates leakage during use of the bottle assembly 800 in either discussed configuration.

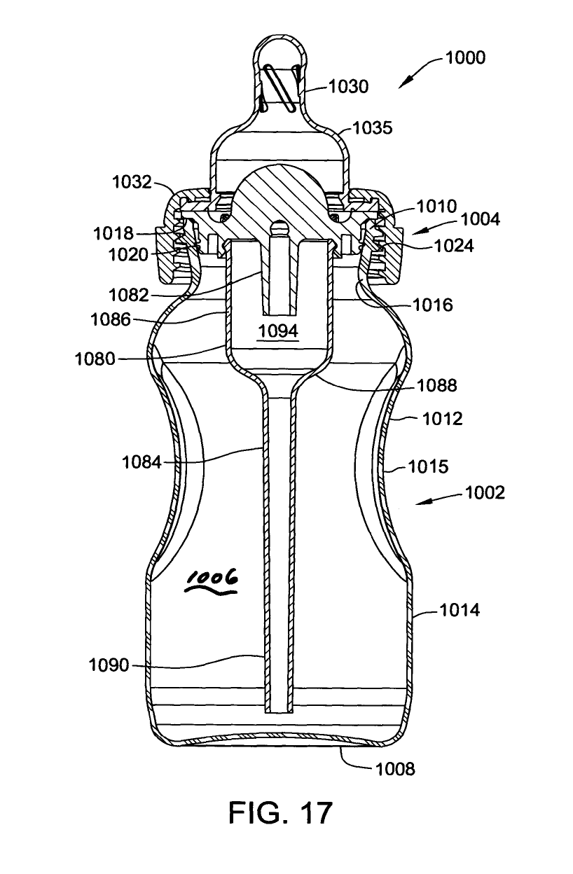

With reference now to FIG. 17, a bottle assembly according to a fourth embodiment is generally indicated at 1000 and is similar to the bottle assembly 100 of FIGS. 1-3, the bottle assembly 300 of FIGS. 4 and 5, and the bottle assembly 800 of FIGS. 8 and 14-16. The bottle assembly 1000 of this embodiment includes a container 1002 such as a bottle and more particularly a nursing bottle in the illustrated embodiment, and a collar assembly, generally indicated at 1004 for generally closing the bottle. The container 1002 includes a liquid chamber 1006 defined therein and adapted to hold a quantity of liquid for consumption by a user, such as a nursing infant. It is also understood that the container 1002 may be configured other than as illustrated herein, and may be configured for use other than as a nursing bottle assembly, such as a sports bottle, a drink tumbler, a training cup, a commuter cup, etc. The container 1002 may be made of any suitable material such as, without limitation, glass, polypropylene or other plastic, aluminum, or stainless steel. The container 1002 can also be made in any desired color or colors, and may be transparent, translucent, or opaque.

The container 1002 has a closed bottom 1008, an open top 1010, and a side wall 1012 extending between the closed bottom 1008 and the open top 1010. The side wall 1012 includes a base portion 1014 and a neck 1016 that is narrowed with respect to the base portion 1014. That is, the neck 1016 has a smaller diameter than the base portion 1014. It is understood that in other embodiments the neck 1016 diameter may only be slightly smaller than the diameter of the base portion 1014, or even the same diameter as the base portion, without departing from the scope of this invention. As best seen in FIG. 17, the base portion 1014 includes a middle segment 1015 that is narrowed with respect to the rest of the base portion for facilitating easier grasping of the container 1002. It is understood that in other embodiments, the side wall 1012 may instead be generally cylindrical as in previous embodiments without departing from the scope of this invention. The neck 1016 includes an annular rim 1018, an externally threaded portion 1020, and a shoulder 1022 defined at the transition between the neck 1016 and the base portion 1014. The threaded portion 1020 includes threads 1024 for assembling the container 1002 to the collar assembly 1004 as described later herein.

The collar assembly 1004 of the bottle 1000 is adapted for removable attachment to the container 1002 for selectively holding a nipple 1030 on the container 1002. The illustrated collar assembly 1004 includes the nipple 1030 and a collar 1032. The nipple 1030 and the collar 1032 can each be made of any suitable material. In one embodiment, for example, the nipple 1030 is made of a substantially pliable material such as at least one of a rubber material, a silicone material, and a latex material, and the collar 1032 is made of polypropylene. The nipple 1030 and the collar 1032 can be made in any desired color or colors, and may be transparent, translucent, or opaque.

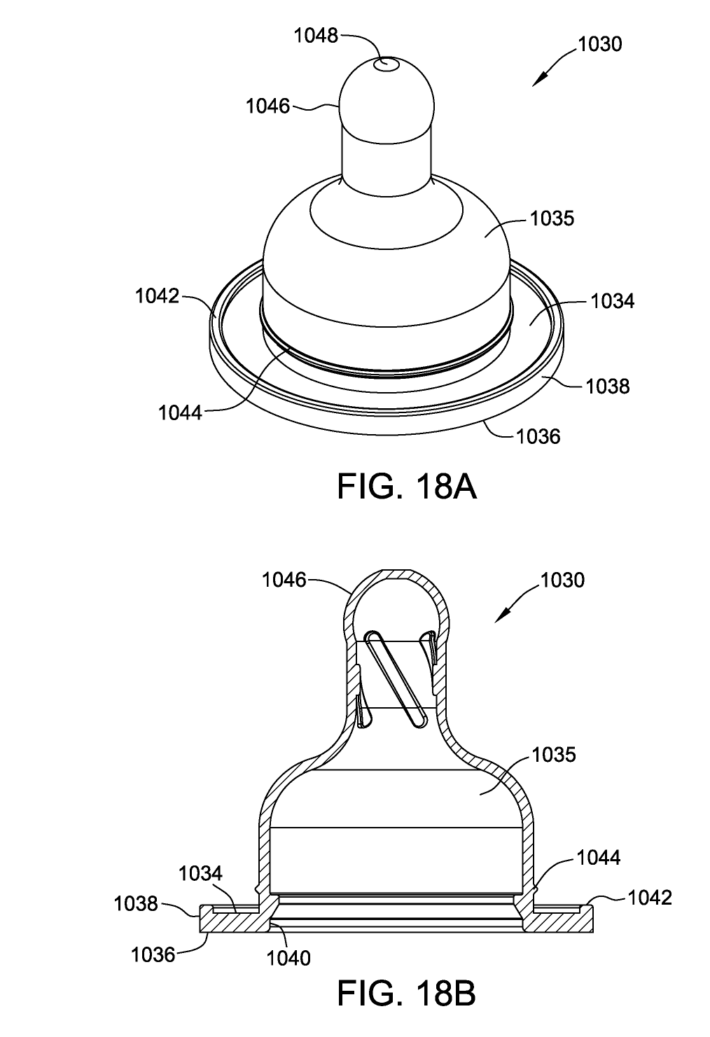

In the illustrated embodiment of FIGS. 18A and 18B, the nipple 1030 includes a nipple portion 1035 and a transversely extending flange 1034. The nipple flange 1034 includes a bottom face 1036 that extends from a generally circular outer edge 1038 to a generally circular inner edge 1040. In the illustrated embodiment, a peripherally extending lip 1042 projects up from the flange generally adjacent the circular outer edge 1038. In at least some alternative embodiments, the nipple 1030 does not include a peripherally extending lip 1042. The nipple portion 1035 extends up from the flange 1034 generally adjacent the circular inner edge 1040 thereof. As illustrated in FIG. 18B, the nipple portion 1035 includes an annular external projection 1044 that projects radially outward. The nipple portion 1035 also includes an outlet end 1046 including an aperture 1048 for dispensing liquid to the user. It is contemplated, however, that the nipple 1030 can have different shapes and sizes than those illustrated and described herein without departing from the present invention.

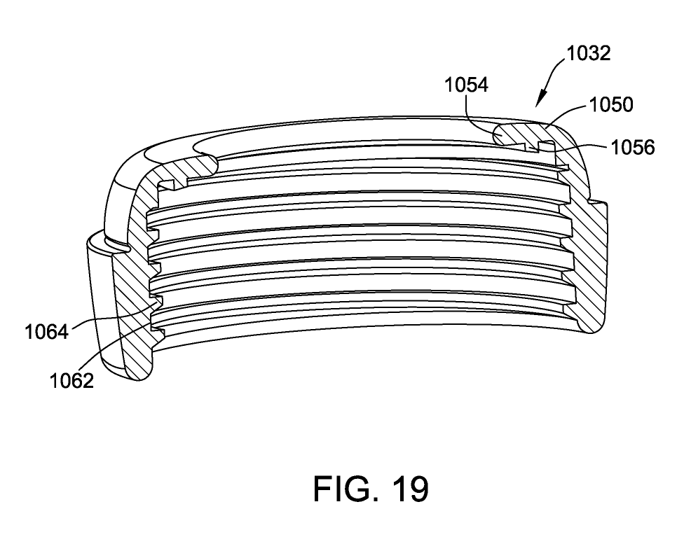

The illustrated collar 1032, best seen in FIG. 19, has an annular top panel 1050 and a depending side wall 1052. The top panel 1050 includes an annular projection 1056 that extends downward from the underside of the panel proximate an annular nub or radially inner edge margin 1054 of the top panel 1050. The edge margin 1054 and the annular projection 1056 facilitate assembly of the nipple 1030 on the collar 1032. To assemble the collar assembly 1004, the nipple 1030 is pulled, nipple portion 135 first, up through the central opening in the top panel 1050 of the collar 1032 until edge margin 1054 is positioned below the annular external projection 1044 of the nipple 1030, and the annular projection 1056 of the collar 1032 is positioned radially inward of the peripheral lip 1042 of the nipple 1030. It is understood, however, that the nipple 1030 and collar 1032 may be configured other than as illustrated and still otherwise configured for assembly together for further assembly onto the container 1002. It is also contemplated that in other embodiments the nipple 1030 and collar 1032 need not be capable of being held in assembly for conjoint assembly onto the container 1002.

The side wall 1052 of the collar 1032 has an inner surface 1062 with suitable internal threads 1064 for threaded engagement with the external threads 1024 of the neck 1016 of the container 1002 to releasably secure the collar and hence the collar assembly 1004 on the container 1002. Again in this embodiment, as illustrated in FIG. 17, the number of threads 1064 on the inner surface 1062 of the collar side wall 1052 exceeds the number of external threads 1024 on the neck 1016 of the container.

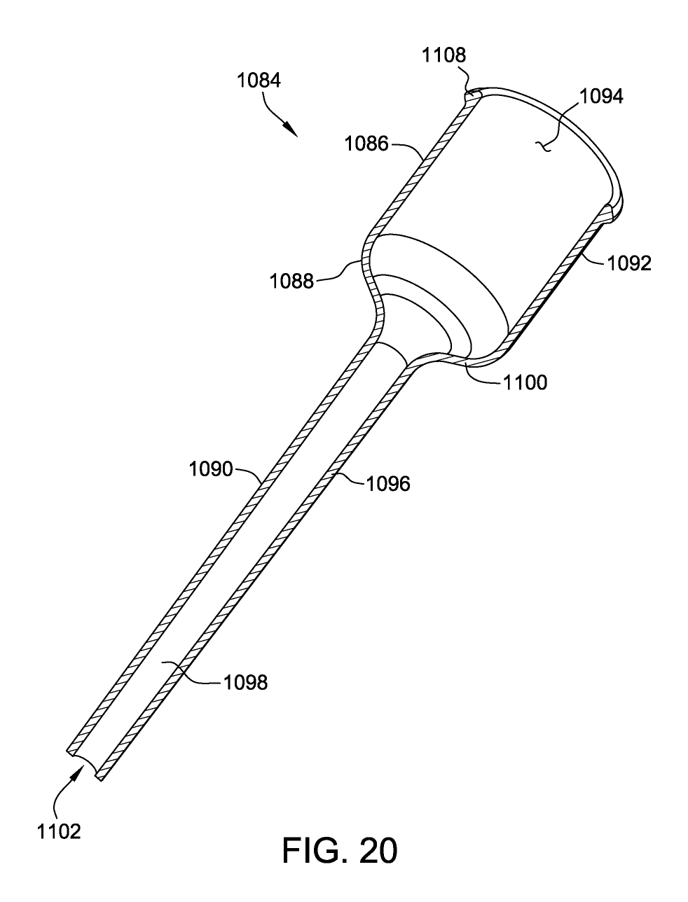

With reference to FIGS. 17-22, the bottle assembly 1000 also includes a vent assembly 1080 to permit venting of the bottle assembly during use. In FIG. 23, the vent assembly 1080 is omitted. The vent assembly 1080 includes a vent insert 1082 and a receptacle portion 1084. As seen in FIG. 20, the receptacle portion 1084 is releasably attachable to the vent insert 1082. The receptacle portion 1084 includes a top 1086, a middle portion 1088, and an elongate vent tube 1090. The top 1086 includes a generally cylindrical side wall 1092 that defines a reservoir 1094 therein. The cylindrical shape is for ease of manufacturing/molding, but it is understood that the top 1086 of the receptacle portion 1084 may be of other suitable shapes. The receptacle vent tube 1090 includes a generally cylindrical side wall 1096 that has a smaller diameter than the side wall 1092 of the top 1086. The side wall 1096 of the receptacle vent tube 1090 defines a passage 1098 that is in fluid communication with the reservoir 1094. The middle portion 1088 includes a tapered side wall 1100 that extends between the receptacle vent tube side wall 1096 and the top side wall 1092. The receptacle vent tube 1090 also includes an air outlet 1102 at an end of the passage 1098 proximate the closed bottom 1008 of the container 1002.

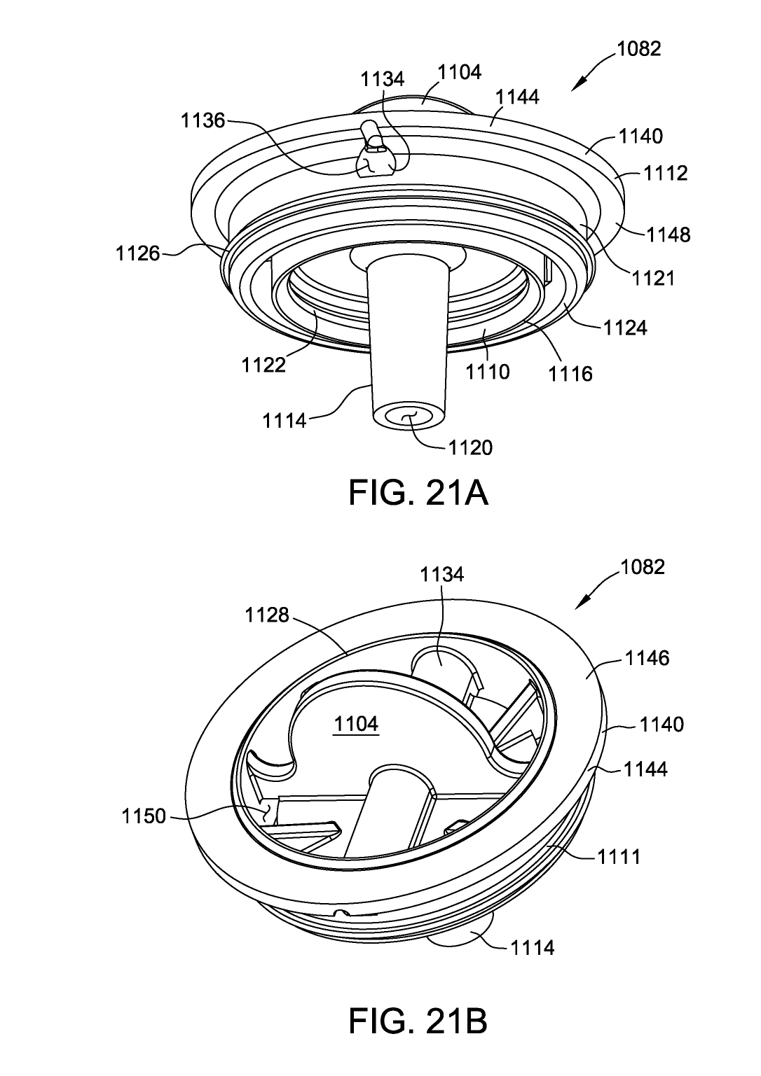

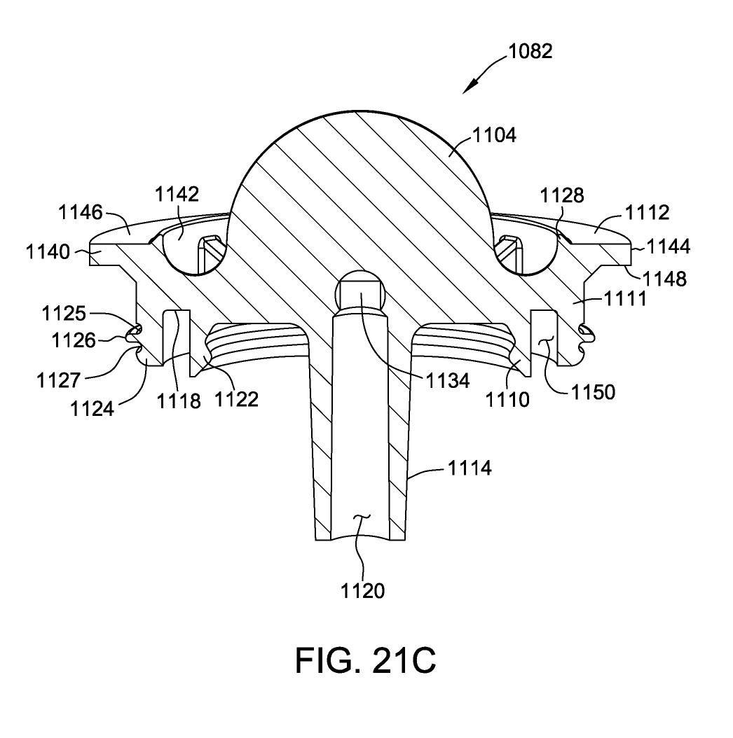

As illustrated in FIGS. 21A-21C, the vent insert 1082 includes an inner portion 1110, an intermediate portion 1111, and an outer portion 1112. The inner portion 1110 includes an internal vent tube 1114, a lip 1116, and a top wall 1118 extending between and oriented orthogonal to the internal vent tube 1114 and lip 1116. The internal vent tube 1114 defines a passage 1120 in flow communication with the reservoir 1094. To assemble the vent insert 1082 to the receptacle portion 1084, the lip 1116 is configured to engage the side wall 1092 of the receptacle portion 1084.

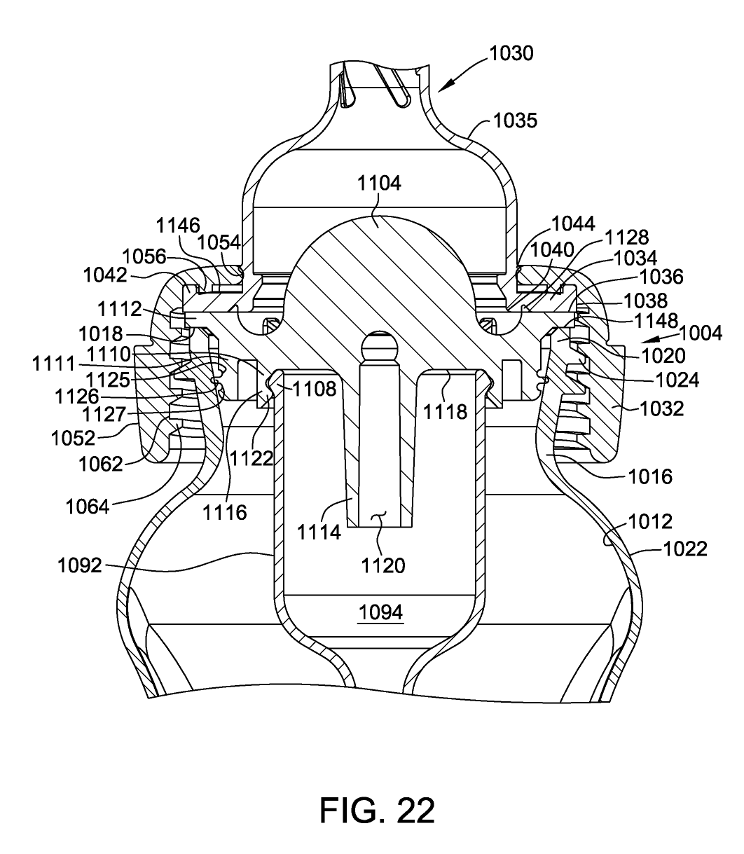

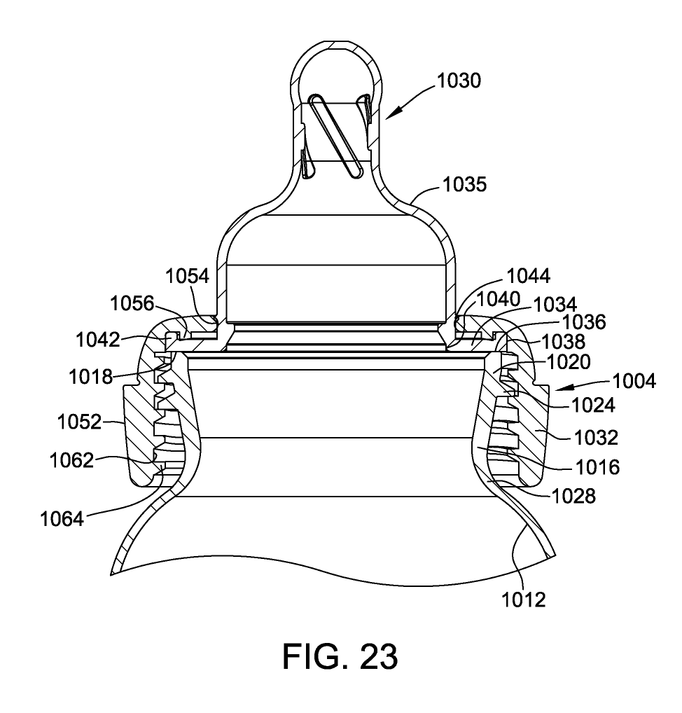

In a particularly suitable embodiment, as best illustrated in FIG. 22, the lip 1116 of the vent insert 1082 and the top 1086 of the receptacle portion 1084 are configured to provide a latch and catch type connection between the receptacle portion and the vent insert. For example, in the illustrated embodiment the lip 1116 of the vent insert 1082 includes an annular rib or bulge 1122 projecting radially inward of the lip to generally define a catch. In this particular embodiment, the bulge 1122 is formed by providing an annular channel formed radially inward of the lip 1116 above the bulge 1122. In addition to defining the bulge to thus broadly define a catch, this annular channel accommodates the receptacle portion 1084 upon connection of the receptacle portion to the vent insert. It is understood, however, that the lip may instead be of generally uniform cross-section above the bulge 1122 and the rib or bulge formed of a radially inward projection from the lip.

A corresponding rib or bulge 1108 projects radially outward from adjacent the rim of the side wall 1092 of the top 1086 of the receptacle portion 1084 to broadly define a latch. During assembly of the vent assembly 1080, the side wall 1092 of the receptacle portion 1094 is inserted along a central axis of the vent insert 1082 into the lip 1116 of the vent insert 1082. The flexibility of the vent insert 1082 allows the lip 1116 diameter to expand outward slightly to allow the bulge 1108 (broadly, the latch) of the side wall 1092 of the receptacle portion 1084 to move past the bulge 1122 (broadly, the catch) of the lip. Once the bulge 1108 of the side wall 1092 is past the bulge 1122 of the lip 1116, the lip resiliently retracts toward its unexpanded state such that the bulge 1108 of the side wall seats in the channel above the bulge 1122 of the lip as illustrated in FIG. 22 to releasably retain the receptacle portion 1084 on the vent insert 1082. As best illustrated in FIG. 22, the lower end of the lip 1116 (e.g., below the bulge 1122) and the rim of the side wall 1092 of the top 1086 of the receptacle portion 1084 (e.g., above the bulge 1108) are tapered to facilitate urging of the lip 1116 radially outward and to further facilitate sliding movement of the receptacle portion into the lip upon initial insertion of the receptacle portion into the lip.

This latch and catch type of arrangement in which the receptacle portion 1084 is inserted into the lip 1116 of the vent insert 1082 (instead of friction fitting around the outer surface of the lip of the vent insert) facilitates better retention and centering of the receptacle portion on the vent insert and inhibits tilting of the receptacle portion relative to the vent insert during assembly and/or use of the bottle. In other embodiments, the lip 1116 of the vent insert 1082 and the side wall 1092 of the top 1086 of the receptacle portion 1084 may be configured such that the lip 1116 broadly defines a latch and the side wall 1092 broadly defines a catch without departing from the scope of this invention. It also contemplated that in some embodiments the rib or bulge 1108 projecting radially outward from the side wall 1092 of the top 1086 of the receptacle portion 1084 may be located longitudinally spaced below the rim of the top of the receptacle portion. In other alternative embodiments, it is contemplated that the lip 1116 of the vent insert 1082 and the top 1086 of the receptacle portion 1084 may be straight side or tapered to otherwise releasably connect the receptacle portion to the vent insert in a press-fit manner—as long as the top of the receptacle portion is still received internally of the lip of the vent insert.

With reference back to FIGS. 21A-C, the inner portion 1110 of the vent insert 1082 further includes a lateral vent 1134 extending upward from the top wall 1118 to define a channel 1136 within the vent insert 1082. The vent insert 1082 of this embodiment further includes a tab 1104 projecting upward from the vent insert 1082. This tab 1104 is suitably sized in one embodiment to extend longitudinally outward of the neck 1016 of the container 1002 when the vent insert is assembled with the container. This facilitates gripping of the tab 1104 by a user to make it easier to pull the vent insert 1082 out of the container 1002 for disassembly of the bottle 1000, such as for cleaning or for refilling the container. In other embodiments, the tab 1104 need not be sized to extend above the neck 1016 of the container 1002 as long as it is sufficiently sized for gripping by the user to pull the insert 1082 out of the container.

The intermediate portion 1111 of the vent insert 1082 is positioned radially between the inner portion 1110 and the outer portion 1112 with respect to a center of the vent insert 1082. The intermediate portion 1111 includes a depending container engaging lip 1124 configured to abut an inner surface of the side wall 1012 of the container 1002, and more particularly at the neck 1016 of the container. In particular, the container engaging lip 1124 has an annular rib or bulge 1126 extending radially outward therefrom for frictional engagement with the inner surface of the side wall 1012 (and more particularly the inner surface of the neck 1016) of the container 1002. In this embodiment, a pair of annular notches (first and second notches) 1125, 1127 is formed radially into the outer surface of the container engaging lip 1124, immediately above and immediately below the annular bulge 1126. The notches 1125, 1127 increase the flexibility of the annular bulge 1126 relative to the lip 1124 such that bending or other displacement of the annular bulge 1126 upon sliding movement and frictional engagement with the inner surface of the neck 1016 of the container 1002 is more predictable than without the notches (e.g., as in the previous embodiments herein). This added flexibility also allows for easier insertion and removal of the vent insert 1082 into and from the container with the annular bulge 1126 still in sufficiently sealing engagement with the neck 1016 of the container 1002.

In this fourth embodiment, as illustrated in FIGS. 17 and 22, the neck 1016 of the container 1002 is suitably configured to have an inner diameter that tapers outward from the bottom of the neck to the rim 1118 of the container. As such, the annular rib or bulge 1126 extending radially outward from the container engaging lip 1124 sealingly engages the inner surface of the neck 1016 of the container 1002 intermediate the bottom of the neck and the rim 1118 of the container. The outward tapering of the diameter of the inner surface of the neck 1016 further facilitates easier insertion and removal of the vent insert into and from the container 1002 because the annular bulge 1126 meets with less frictional resistance against the inner surface of the neck above the target location at which the bulge sealingly engages the neck.

The outer portion 1112 of the vent insert 1082 includes a perimeter wall 1140. The perimeter wall 1140 includes an inner edge 1142, an outer edge 1144, a top 1146, and a bottom 1148. The bottom 1148 is configured to sit on the annular rim 1018 of the container 1002 when the bottle assembly 1000 is assembled, as best seen in FIG. 22. The outer portion 1112 may further include an annular rib 1128 projecting from the top 1146 of the perimeter wall 1140. The annular rib may serve to compress and/or deform the flange 1034 of the nipple 1030 when the collar assembly 1004 is attached to the container 1002 in order to reduce leakage during use of the bottle assembly 1000. The annular rib 1128 may also sealingly engage the bottom face 1036 of the nipple 1030 in a configuration in which the bottle assembly 1000 includes the vent assembly 1080.

The perimeter wall 1140 has at least one vent (not shown) such that the channel 1136 extends through the perimeter wall 1140. Gaps 1150 defined between the perimeter wall 1140 and the top wall 1118 enable liquid in the liquid chamber 1006 (FIG. 17) to flow towards the nipple 1030. Inserting the receptacle portion 1084 into the lip 1116 of the vent insert 1080 as described above (instead of around the outside of the lip as in the previous embodiments) avoids blocking or reducing the flow of liquid through the gaps 1150. It is contemplated, however, that the components of the vent assembly 1080 can have different shapes and sizes than those illustrated and described herein without departing from some aspects of this invention.

As illustrated in FIGS. 17, 22, and 23, the collar side wall 1052 and the container neck 1016 are suitably sized relative to each other to permit operation of the bottle assembly 1000 in two different configurations, a first configuration (FIG. 22) in which the vent assembly 1080 is included and a second configuration (FIG. 23) in which the vent assembly is omitted. For example, in the illustrated embodiment, the length (or height in the orientation of the drawings herein) of the container neck 1016 (e.g., from the rim 1018 of the container 1002 to the shoulder 1022 where the neck widens outward to the base portion 1014 of the container) is sufficient to accommodate the side wall 1052 of the collar in the second configuration, i.e., when the vent assembly is omitted as illustrated in FIG. 23. The bottle assembly 1000 is transitioned between the first configuration and the second configuration as described above with respect to the bottle assembly 1000, the bottle assembly 300, and the bottle assembly 800.

As seen in FIG. 22, in the first configuration, where the bottle assembly 1000 includes the vent assembly 1080, the vent assembly 1080 is inserted into the container 1002 such that the bottom 1148 of the perimeter wall 1140 seats down against the rim 1018 of the container. After the vent assembly 1080 is inserted within the container 1002, the collar assembly 1004 is attached to the container 1002 by threadably engaging the internal collar threads 1064 with the external threads 1024 of the neck 1016 and rotating the collar 1032 to twist the collar down onto the container. As the collar 1032 is tightened onto the container 1002, the bottom face 1036 of the nipple 1030 is urged against the top 1146 of the perimeter wall 1140 of the vent assembly 1080 to seal the nipple (and hence the collar assembly 1004) against the vent assembly. Concurrently, the bottom 1148 of the perimeter wall 1140 of the vent assembly is urged against the rim 1018 of the container 1002 to seal the vent assembly against the container.

In this configuration, some of the lower threads 1064 of the collar engage the threads 1024 of the neck, while the uppermost collar threads oppose the perimeter wall 1140 of the vent assembly. As illustrated in FIG. 109, the collar side wall 1052 is sufficiently long such that in the first configuration, the lower end of the collar side wall extends below the lowermost threads 1024 of the neck 1016 so that no external threads are visible when the collar assembly 1004 is secured to the container 1002.

In the second configuration, illustrated in FIG. 23, the vent assembly 1080 is omitted. The collar 1032 is configured to tighten down an additional vertical distance approximately equal to a height of the perimeter wall 1140 of the outer portion 1112 of the vent insert 1082 such that the bottom face 1036 of the nipple 1030 seats on the annular rim 1018 of the container 1002. In such an embodiment, because the collar 1032 is configured to tighten down the additional vertical distance, the collar 1032 can securely seat the nipple 1030 to the annular rim 1018 in order to minimize or even eliminate leakage of liquid from the bottle assembly 1000 when used without the vent assembly 1080.

As illustrated in FIG. 22, the vent insert 1082 is constructed such that the height of the outer portion 1112 (more specifically, the height of the perimeter wall 1140) is relatively narrow compared to the rest of the vent insert 1082. This is achieved by, among other features, providing the channel 1136 of the lateral vent 1134 below the outer portion 1112 such that the channel 1136 (or, alternatively, a portion of the channel 1136) ultimately sits below the annular rim 1018 of the container 1002 when the vent insert 1082 is in the assembled position. Accordingly, the height of the perimeter wall 1140 of the outer portion 1112 may be narrower than otherwise would be necessary to accommodate the channel 1136 of the lateral vent 1134 if the channel 1136 was provided above the annular rim 1018 of the container 1002 when assembled (as is common for many known vent assemblies).

Such relative dimensions of the vent insert (i.e., the narrowness of the perimeter wall 1140 relative to the other features of vent insert 1082) allows the bottle assembly 1000 to be assembled in two configurations while minimizing leakage from the bottle assembly 1000 in each configuration. For example, and as best seen in FIG. 22, in a first configuration, the bottle assembly 1000 includes the vent assembly 1080. In this configuration, the vent assembly 1080 is inserted into the container 1002 such that the bottom 1148 of the perimeter wall 1140 of the vent insert 1082 seats down against the rim 1018 of the container 1002, and such that the container engaging lip 1124 (or more particularly the container engaging bulge 1126) frictionally engages an inner surface of the side wall 1012 of the container 1002. After the vent assembly 1080 is inserted in such a position, the collar assembly 1004 is attached to the container 1002 by threadably engaging the internal collar threads 1064 with the external threads 1024 of the neck 1016 and rotating the collar 1032 to twist the collar down onto the container 1002. As the collar 1032 is tightened onto the container 1002, the bottom face 1036 of the nipple 1030 is urged against the top 1146 of the perimeter wall 1140 and against the annular rib 1128 of the vent insert 1082 to seal the nipple 1030 (and hence the collar assembly 1004) against the vent assembly 1080. Concurrently, the bottom 1148 of the perimeter wall 1140 of the vent insert 1082 is urged against the rim 1018 of the container 1002 to position the vent assembly 1080 on the container 1002.

In this configuration, the collar threads 1064 engage the threads 1024 of the neck such that no threads are visible below the collar 1032. More particularly, the collar side wall 1052 is sufficiently long such that in the first configuration, the bottom edge 1051 of the collar side wall 1052 extends below the lowermost external thread 1024 of the neck 1016 so that no external threads 1024 are visible when the collar assembly 1004 is secured to the container 1002. Further, because the collar assembly 1004 securely seats the nipple 1030 and the vent assembly 1080 to the rim 1018 of the container 1002, leakage is minimized during use of the bottle assembly 1000.

In the second configuration, as illustrated in FIG. 23, the vent assembly 1080 is omitted from the bottle assembly 1000. In such a configuration, when the collar assembly 1004 is tightened down onto the container 1002, the collar threads 1064 engage the threads 1024 of the neck 1016 of the container 1002 and the collar 1032 is rotated to twist the collar 1032 down onto the container 1002 until the nipple 1030 is urged against the rim 1018 of the container 1002 to seal the nipple 1030 directly against the container 1002. Accordingly, the collar assembly 1004 will ultimately be twisted a greater distance than in the first configuration before it is fully seated on the container 1002. That is, because the vent assembly 1080 (and accordingly the vent insert 1082) is omitted from the bottle assembly 1000 in this configuration, the collar assembly 1004 will need to be tightened down an additional vertical distance approximately equal to the height of perimeter wall 1140 of the omitted vent inset 1082. However, because the vent insert 1082 is constructed as described (e.g., because the channel 1136 of the lateral vent 1134 is disposed below the outer portion 1112 of the vent insert 1082), the perimeter wall 1140 is relatively narrow and thus the collar 1032 does not require much additional tightening than when the vent assembly 1080 is included (as depicted in FIG. 22). Accordingly, in the second configuration, the collar assembly 1004 can be fully tightened (i.e., fully assembled such that the nipple 1030 securely engages the container 1002) before the side wall 1052 of the collar 1032 engages with the lip 1026 and/or the shoulder 1022.

When introducing elements of the present invention or the various versions, embodiment(s) or aspects thereof, the articles “a”, “an”, “the” and “said” are intended to mean that there are one or more of the elements. The terms “comprising”, “including” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above without departing from the scope of the invention, it is intended that all matter contained in the above description and shown in the accompanying drawings shall be interpreted as illustrative and not in a limiting sense.

What is claimed is:

1. A bottle assembly comprising:
a container having an open end, a closed end, a base portion, and a neck together defining a liquid chamber within the container, the neck having a rim defining the open end of the container, the container having a central axis;
a vent assembly positionable at least in part on the rim of the container to permit venting of the container during use and comprising at least one lateral vent extending other than parallel to the central axis of the container when the vent assembly is positioned on the rim of the container, the vent assembly comprising a vent insert and a receptacle portion releasably connectable to the vent insert, the vent insert including the at least one lateral vent and further comprising an annular lip depending longitudinally within the container upon positioning of the vent assembly on the rim of the container, the annular lip having a transversely inner surface, said inner surface of the annular lip having one of a catch and a latch, the receptacle having a top and a vent tube extending downward from the top, the top of the receptacle including a transversely outer surface having the opposite one of a catch and a latch, the top of the receptacle being insertable into the annular lip for releasable latch and catch connection of the receptacle to the vent insert; and
a collar assembly generally defining a closure for the container, the collar assembly configured for releasable engagement with the neck of the container over the open end thereof to retain the vent assembly together with the container.

2. The bottle assembly of claim 1 wherein the collar assembly and the container are configured relative to each other to enable selective configuration of the bottle assembly between a first configuration in which the vent assembly is disposed substantially entirely within the liquid chamber of the container and a second configuration in which the vent assembly is omitted from the container.

3. The bottle assembly set forth in claim 2 wherein in the first configuration, the collar assembly is configured to sealingly engage the vent assembly and urge the vent assembly into sealing engagement with the rim of the container, and wherein in the second configuration, in which the vent assembly is omitted from the bottle assembly, the collar assembly is configured to sealingly engage the rim of the container.

4. The bottle assembly set forth in claim 3 wherein the neck of the container comprises external threads thereon, and wherein the collar assembly comprises internal threads for threaded engagement with the external threads of the neck of the container, the number of internal threads on the collar assembly being greater than the number of external threads on the neck of the container.

5. The bottle assembly set forth in claim 3 wherein the collar assembly comprises a collar and a nipple, in the first configuration of the bottle assembly the nipple sealingly engaging the vent assembly, and in the second configuration of the bottle assembly the nipple sealingly engaging the rim of the container.

6. A bottle assembly comprising:
a container having an open end, a closed end, a base portion, and a neck together defining a liquid chamber within the container, the neck having a rim defining the open end of the container, the container having a central axis, the neck of the container having a base disposed below the rim of the container, said neck having a diameter that tapers outward as the neck extends upward from its base to the rim of the container;
a vent assembly positionable at least in part on the rim of the container to permit venting of the container during use and comprising at least one lateral vent extending other than parallel to the central axis of the container when the vent assembly is positioned on the rim of the container, the vent assembly further having a container engagement lip extendable longitudinally within the interior space of the container upon positioning of the vent assembly on the rim of the container, the container engagement lip having an annular bulge extending at least in part radially outward therefrom, the annular bulge being sized for sealing engagement with the neck of the container intermediate the base of the neck and the rim of the container; and
a collar assembly generally defining a closure for the container, the collar assembly configured for releasable engagement with the neck of the container over the open end thereof to retain the vent assembly together with the container.

7. The bottle assembly as set forth in claim 6 wherein the container engagement lip further comprises an annular notch formed therein immediately adjacent the annular bulge.

8. The bottle assembly as set forth in claim 7 wherein the annular notch comprises a first annular notch formed in the container engagement lip immediately adjacent the annular bulge on one longitudinal side of the annular bulge, the container engagement lip further comprising a second annular notch formed therein immediately adjacent the annular bulge on the opposite longitudinal side of said annular bulge.

9. The bottle assembly of claim 6 wherein the collar assembly and the container are configured relative to each other to enable selective configuration of the bottle assembly between a first configuration in which the vent assembly is disposed substantially entirely within the liquid chamber of the container and a second configuration in which the vent assembly is omitted from the container.

10. The bottle assembly set forth in claim 9 wherein in the first configuration, the collar assembly is configured to sealingly engage the vent assembly and urge the vent assembly into sealing engagement with the rim of the container, and wherein in the second configuration, in which the vent assembly is omitted from the bottle assembly, the collar assembly is configured to sealingly engage the rim of the container.

11. The bottle assembly set forth in claim 10 wherein the neck of the container comprises external threads thereon, and wherein the collar assembly comprises internal threads for threaded engagement with the external threads of the neck of the container, the number of internal threads on the collar assembly being greater than the number of external threads on the neck of the container.

12. The bottle assembly set forth in claim 10 wherein the collar assembly comprises a collar and a nipple, in the first configuration of the bottle assembly the nipple sealingly engaging the vent assembly, and in the second configuration of the bottle assembly the nipple sealingly engaging the rim of the container.

13. A bottle assembly comprising:
a container having an open end, a closed end, a base portion, and a neck together defining a liquid chamber within the container, the neck having a rim defining the open end of the container, the container having a central axis;
a vent assembly positionable at least in part on the rim of the container to permit venting of the container during use and comprising at least one lateral vent extending other than parallel to the central axis of the container when the vent assembly is positioned on the rim of the container, the vent assembly further having a container engagement lip extendable longitudinally within the interior space of the container upon positioning of the vent assembly on the rim of the container, the container engagement lip having an annular bulge extending at least in part radially outward therefrom, the annular bulge being sized for sealing engagement with the neck of the container, said container engagement lip further comprising an annular notch formed therein immediately adjacent the annular bulge; and
a collar assembly generally defining a closure for the container, the collar assembly configured for releasable engagement with the neck of the container over the open end thereof to retain the vent assembly together with the container.

14. The bottle assembly as set forth in claim 13 wherein the annular notch comprises a first annular notch formed in the container engagement lip immediately adjacent the annular bulge on one longitudinal side of the annular bulge, the container engagement lip further comprising a second annular notch formed therein immediately adjacent the annular bulge on the opposite longitudinal side of said annular bulge.

15. The bottle assembly of claim 13 wherein the collar assembly and the container are configured relative to each other to enable selective configuration of the bottle assembly between a first configuration in which the vent assembly is disposed substantially entirely within the liquid chamber of the container and a second configuration in which the vent assembly is omitted from the container.

16. The bottle assembly set forth in claim 15 wherein in the first configuration, the collar assembly is configured to sealingly engage the vent assembly and urge the vent assembly into sealing engagement with the rim of the container, and wherein in the second configuration, in which the vent assembly is omitted from the bottle assembly, the collar assembly is configured to sealingly engage the rim of the container.

17. The bottle assembly set forth in claim 16 wherein the neck of the container comprises external threads thereon, and wherein the collar assembly comprises internal threads for threaded engagement with the external threads of the neck of the container, the number of internal threads on the collar assembly being greater than the number of external threads on the neck of the container.

18. The bottle assembly set forth in claim 16 wherein the collar assembly comprises a collar and a nipple, in the first configuration of the bottle assembly the nipple sealingly engaging the vent assembly, and in the second configuration of the bottle assembly the nipple sealingly engaging the rim of the container.

19. A bottle assembly comprising:
a container having an open end, a closed end, a base portion, and a neck together defining a liquid chamber within the container, the neck having a rim defining the open end of the container, the container having a central axis;
a vent assembly positionable at least in part on the rim of the container to permit venting of the container during use and comprising at least one lateral vent extending other than parallel to the central axis of the container when the vent assembly is positioned on the rim of the container, the vent assembly further having a grip tab accessible when the vent assembly is positioned on the rim of the container to facilitate gripping by a user to remove the vent assembly from the container; and
a collar assembly generally defining a closure for the container, the collar assembly configured for releasable engagement with the neck of the container over the open end thereof to retain the vent assembly together with the container.

20. The bottle assembly as set forth in claim 19 wherein with the collar removed from the container, the grip tab of the vent assembly extends longitudinally outward of the rim of the container.

21. The bottle assembly of claim 19 wherein the collar assembly and the container are configured relative to each other to enable selective configuration of the bottle assembly between a first configuration in which the vent assembly is disposed substantially entirely within the liquid chamber of the container and a second configuration in which the vent assembly is omitted from the container, the grip tab extending at least in part outward of the container in the first configuration of the vent assembly.

22. The bottle assembly set forth in claim 21 wherein in the first configuration, the collar assembly is configured to sealingly engage the vent assembly and urge the vent assembly into sealing engagement with the rim of the container, and wherein in the second configuration, in which the vent assembly is omitted from the bottle assembly, the collar assembly is configured to sealingly engage the rim of the container.

23. The bottle assembly set forth in claim 22 wherein the neck of the container comprises external threads thereon, and wherein the collar assembly comprises internal threads for threaded engagement with the external threads of the neck of the container, the number of internal threads on the collar assembly being greater than the number of external threads on the neck of the container.

24. The bottle assembly set forth in claim 22 wherein the collar assembly comprises a collar and a nipple, in the first configuration of the bottle assembly the nipple sealingly engaging the vent assembly, and in the second configuration of the bottle assembly the nipple sealingly engaging the rim of the container.
